(19) United States
(12) Patent Application Publication
(10) Pub. No.: US 2016/0140519 A1
(43) Pub. Date: May 19, 2016

(54) AGGREGATING SYSTEM

(71) Applicants: Sebastjan TREPCA, London (GB); Miyon IM, London (GB); Eddie BELL, London (GB); Jonathan HEUSSER, London (GB); Maciej KULA, London (GB); Gregor AMBROZIC, London (GB); Carl ELLIS, London (GB)

(72) Inventors: Sebastjan Trepca, London (GB); Miyon Im, London (GB); Eddie Bell, London (GB); Jonathan Heusser, London (GB); Maciej Kula, London (GB); Gregor Ambrozic, London (GB); Carl Ellis, London (GB)

(21) Appl. No.: 14/896,253

(22) PCT Filed: Jun. 4, 2014
(86) PCT No.: PCT/GB2014/000212

§ 371 Date: Dec. 4, 2015

(30) Foreign Application Priority Data
Jun. 4, 2013 (GB) 1310007.8
Jul. 23, 2013 (GB) 1313153.7

(51) Int. Cl. G06Q 20/08; G06Q 30/06; G06N 7/00; G06F 17/30

(52) U.S. Cl. CPC G06Q 20/0855; G06F 17/30864; G06F 17/30424; G06Q 30/0619; G06N 7/005

(57) ABSTRACT

A method of facilitating an on-line transaction, the method comprising determining a first format of transaction details as required by a merchant server for the processing of the transaction; acquiring user information relating to the transaction from a user in a second format; and transmitting the user information relating to the transaction to the merchant server in the first format. An associated apparatus is also described.

The present invention relates to apparatus for and methods of data aggregation and transaction processing in an aggregating system (preferably, herein also referred to as a “merchant system”) such as used in on-line electronic commerce. Aspects of the invention relate to means for maintaining data integrity, the classification and recommendation of data and/or items, and the provision of an integrated data request system and/or checkout. Some of these aspects are of particular relevance facilitating data access and/or commerce on mobile devices.

Online electronic commerce is now commonplace, with the number of users purchasing products online increasing annually.

Popularity is not however reflected in consistency, and the online shopper is frequently confronted with the need to register separately at each merchant, and to learn to navigate disparate online shopping interfaces.

At the same time, certain purchasing methods, such as the on-line “shopping basket” metaphor, have become standard and are expected by online purchasers.

These various issues are particularly acute for users of mobile devices, having limited computing resources (both in terms of processing power and network speed/bandwidth), as well as limited screen real-estate compared to those with desk-top computer systems. Some web interfaces provide a poor experience for users accessing them via mobile devices, for example by rendering inaccurately. Even those which are optimised for mobile devices will often require the completion of various online forms with user details, which can become tiresome—a drawback which is also experienced by users of non-mobile devices.

This is particularly the case in certain fast-moving areas of commerce, such as fashion, characterised by a plurality of small merchants or boutiques. Such merchants often lack the resources to ensure their own e-commerce systems have a high conversion rate (of sales/visit) by providing a user-friendly and attractive experience for their users, and also to ensure that such systems are robust and up-to-date.

There is therefore a need for a more fluid data access and/or shopping experience, one which in some embodiments is particularly geared to the mobile device, but which may provide advantages to users of many different types of devices seeking a better data access and/or shopping experience.

This invention aims to provide such a system by addressing at least some of the issues identified above.

The following terms may be used interchangeably:
merchant, retailer, producer, supplier, vendor
customer, user
product, merchandise, item
robot, 'bot, agent
spider, crawler, indexer

The term ICON refers to Integrated Check-Out Network.

The invention may provide one or more of the following:
an online merchant store (preferably as stored on an external (remote) server), typically accessible as a web-site via a web browser or (typically for mobile devices) via a dedicated application
aggregation of product data from a plurality of remote servers and/or merchant partners
data acquisition via data feeds from and/or ‘crawling’ or ‘scraping’ of remote servers and/or merchant websites
use of retailer-specific rules-based scraping of remote servers and/or retailer websites to build-up an inventory of available items from a plurality of retailers
social functionality on-site to allow users to discover products
in some embodiments, an affiliate model in which the user is passed to the merchant web site with an accompanying electronic tag identifying him as having been referred from the merchant system
a marketplace and/or with an integrated checkout model in which user or customer information is gathered and transactions are made on the customer's behalf on one or more merchants' web sites without the customer having to go on the merchant site—effectively a distributed transaction
user payment information stored in a secure environment, for example using 2048-bit encryption or higher
orders can go through with only, say, two clicks
functionality provided by a user agent or 'bot, wherein:
   information received from the customer is passed to the 'bot in a secure environment
   the 'bot visits the site using a secure web connection
   the 'bot goes through the whole checkout process using user's information
customised rules are used for each retailer
the order ID (once received from the retailer thank-you page) is passed to the user via email
unified experience between different merchants
ease of integration and flexibility
a level of abstraction overlaying the heterogeneous e-commerce systems of a plurality of retailers
a personalised shop front, virtual shop window experience
a shopping bag, comprising a list of items put together by a user with the intention of buying
an item list, a private wish list of (desired) items put together by a user, allowing the user to receive alerts (such as sales and stock alerts) about the items listed
the ability to follow other users of the system
the ability for a user to add to their list an item listed by another user
item recommendation provided by a plurality of hierarchical recommendation engines, with outputs determined by a combination of system and user weightings, at least some originating from user profile information
provision of integration APIs to allow merchants to integrate their own e-commerce systems with that of the merchant system/service provider, preferably without requiring onerous reconfiguration and/or replacement of existing systems; this may also allow parties or merchants without their own e-commerce facilities to interact with the merchant system
provision of publisher APIs to allow external entities, such as popular media (eg. fashion magazines), access to the merchant system

Generally, the term “link” refers to a table in database and represents a product on specific retailer and holds all product attribute values. All internal systems use that when processing data. A “Product” table can hold multiple links. For example, one product can be sold in multiple retailers hence a product may have multiple links.

### Integrated Checkout

According to one aspect of the invention, there is provided a method of facilitating an on-line transaction, the method comprising: determining a first format of transaction details as required by a merchant server (preferably herein also referred to as an “external server”) for the processing of the transaction; acquiring user information relating to the transaction from a user in a second format; and transmitting the user information relating to the transaction to the merchant server in the first format.

Preferably, the determination of the first format is via remote querying of the merchant server over a computer network. More preferably, the remote querying is by means of an agent or spider adapted to crawl a website associated with the merchant server.

Preferably, the method further comprises determining an item which is capable of being the subject of the transaction. Preferably, the method comprises aggregating a plurality of such determinations for a plurality of items, more preferably over a plurality of merchant servers.

Preferably, the method further comprises selecting an item for presentation to a user as an item which is capable of being the subject of a transaction.

Preferably, the method further comprises completing a transaction in respect of an item, preferably in respect of a plurality of items.

According to further aspect of the invention, there is provided apparatus for facilitating an on-line transaction, the apparatus comprising: means for determining a first format of transaction details as required by a merchant server for the processing of the transaction; means for acquiring user information relating to the transaction from a user in a second format; and means for transmitting the user information relating to the transaction to the merchant server in the first format.

### Multiple Merchant Integration

According to another aspect of the invention, there is provided a method of facilitating an on-line transaction, comprising first and second transactions, the method comprising: determining a first format of transaction details as required by a first merchant server for the processing of the first transaction; determining a second format of transaction details as required by a second merchant server for the processing of the second transaction; acquiring user information relating to the transaction from a user in a third format; and transmitting the user information relating to the first transaction to the first merchant server in the first format and the user information relating to the second transaction to the second merchant server in the second format.

Alternatively, the method further comprises transmitting the user information relating to the first transaction to the first merchant server in a third format and the user information relating to the second transaction to the second merchant server in fourth format.

Preferably, the method further comprises completing a transaction in respect of a plurality of items across a plurality of merchant servers.

According to yet another aspect of the invention, there is provided apparatus for facilitating an on-line transaction, comprising first and second transactions, the apparatus comprising: means for determining a first format of transaction details as required by a first merchant server for the processing of the first transaction; means for determining a second format of transaction details as required by a second merchant server for the processing of the second transaction; means for acquiring user information relating to the transaction from a user in a third format; and means for transmitting the user information relating to the first transaction to the first merchant server in the first format and the user information relating to the second transaction to the second merchant server in the second format.

### Velocity Control

According to a further aspect of the invention, there is provided a method of facilitating an on-line transaction, the method comprising: monitoring the addition of items to a shopping basket; and upon detecting the addition of an item to the shopping basket, checking a property of the item by querying a (preferably remote) merchant server for information regarding the property.

Preferably, the method comprises checking the property of the item upon detecting an indication that the transaction is to proceed. More preferably, the method further comprises periodic checking of the property with a frequency dependent on the popularity of the item.

The property may be the stock level of the item; or alternatively, the size, colour and/or price.

### Autoclassifier

According to a further aspect of the invention, there is provided a method of classifying an item in dependence on item information obtained from a remote server, the method comprising: determining the constituent data fields of the item information, the data fields comprising descriptors relating to one or more properties of the item; editing a descriptor for a data field of the item information in conformance with a uniform descriptor taxonomy; and classifying the item in dependence on the edited descriptor.

Preferably, the uniform descriptor taxonomy comprises a standardised set of descriptors.

Preferably, the item information is determined via remote querying of the remote server over a computer network; more preferably, the remote querying is by means of an agent or spider adapted to crawl a website associated with the remote server.

Preferably, the method further comprises storing the item information and the edited descriptor in a database.

Preferably, editing a descriptor comprises replacing the descriptor with a more suitable descriptor, preferably in dependence on at least one item property; more preferably the descriptor is selected from the standardised set of descriptors.

Preferably, the method further comprises obtaining additional item information from a data feed from a remote server; more preferably, determining the item property from the data feed. The data feed may comprise a structured document detailing items available from the merchant. The structured document may contain a textual description of the item.

Preferably, determining a suitable descriptor comprises use of a Support Vector Machine (SVM) model. Preferably, the method comprises training the model on sample data, preferably on data fields present in the data feed.

Preferably, the method further comprises extracting at least one data field and/or descriptor from the data feed; preferably, also determining a suitable descriptor.

Preferably, the method further comprises determining a suitable descriptor comprises predicting at least one field not present in the data feed from the textual description of the item in the data feed. More preferably, the method comprises estimating the likelihood of correctness of the prediction with reference to a probability threshold. Preferably, the probability-threshold is determined using a bounded minimisation algorithm, more preferably by means of the Broyden-Fletcher-Goldfarb-Shanno method.

Preferably, the item property comprises: type, category and/or colour. The item property may comprise: size, gender, designer, description, classification/category and sub-category, name, and/or product code.

In some embodiments, classification may also include one or more of: converting colours into standard colours; performing hashing on item images, preferably to determine the item shape; and/or analysing aspects of the description, preferably as a cross-check of the merchant classification.

Preferably, the merchant comprises a fashion retailer and the item comprises a fashion item.

### Recommendation Engine

According to another aspect of the invention there is provided a method of recommending an item to a user interacting with an aggregation and/or merchant system, the method comprising: determining a user recommendation weighting in dependence on user interaction with the aggregation and/or merchant system; determining a system recommendation weighting in dependence on a property of the item; and determining an item recommendation in dependence on the combination of a user and a system recommendation weightings.

According to another aspect of the invention there is provided a method of recommending an item to a user interacting with an aggregation and/or merchant system, the method comprising determining a first user recommendation weighting in dependence on a first user's interaction with the merchant system; determining a second user recommendation weighting in dependence on a second user's interaction with the aggregation system; and determining in dependence on at least on characteristic shared between said users an item recommendation based on the combination of the first and second user interaction weightings

Preferably, the shared characteristic comprises a user interaction with the aggregation and/or merchant system.

Preferably the shared characteristic comprises interaction with a similar item.

Preferably, at least one recommendation weighting is set by a user-defined parameter. The user-defined parameter may be set directly by the user; alternatively, the user-defined parameter may be determined from information determined from the user.

Preferably, at least one recommendation weighting is adjusted as the user interacts with the merchant system. The recommendation weighting may be determined by one or more of: an external entity, another user and/or the merchant.

Preferably, the method comprises ranking the items according to predicted-preference ordering. More preferably, the ordering is determined by means of a pairwise ranking algorithm. Preferably, the predicted-preference ordering is determined in dependence on one or more of: past actions of the user; item popularity; and item freshness or newness.

Preferably, the method comprises generating a user preference model, the model describing the user preferences over items as a co-efficient vector. The vector may describe user preferences in terms of a combination of basic and latent item features, preferably computed using a collaborative filtering technique.

Preferably, the model is determined according to a modified Weighted Alternating Least Squares WALS algorithm.

Preferably, the modified algorithm comprises:
1) initialisation of an item latent factor matrix:
2) computation of a user matrix, wherein the matrix comprises latent factors corresponding to item latent factors, and content coefficients corresponding to the encoded product metadata; and
3) re-computing the factors of the item matrix via regressing the difference of the user-item matrix and the product of the content part of the user and item matrices on user latent factors.

Preferably, the initialisation of the latent factor matrix comprises:
i) initialising the latent item factors using small random values; and
ii) initialising the content-based part of the item matrix using a matrix encoding of item metadata.

Preferably, when combined, user and product models yield personalized ranking scores, for all users over all items.

Preferably, the method further comprise combining or grouping products into a set that is both pleasing to the user as a whole (for example, according to parameters determined to be of importance to the user and/or aesthetically) and meets certain merchandising requirements.

### Proactor

According to another aspect of the invention there is provided a method of maintaining data integrity when updating a database of item data, the item data being obtained via remote querying of a merchant server for data relating to a property of the item, the method comprising: obtaining a new property value; comparing the new property value to a reference; identifying whether the new property value is unlikely to be valid and if so, omitting the new property value when updating the database.

Preferably, the reference is recalculated as successive property values are determined.

Price Protection

Preferably, the reference comprises a probability distribution for the value of the property of the item. More preferably, the reference is determined via a running variance calculation. The probability distribution may be a lognormal distribution; preferably the property value is a price. Preferably, the new property value is determined to be invalid if it deviates from the reference by in excess of a pre-determined amount.

Item Diffing

Preferably, the reference comprises a set of previous property values. Preferably, the new property value is determined to be invalid if it is determined to not be a member of the set of previous values. More preferably, membership of the set of previous values is determined by means of a bloom filter.

De-Duplication

According to another aspect of the invention there is provided a method of determining duplicate database entries, wherein the database entries correspond to images the method comprising:

retrieving an image to be added to the database, determining a plurality of image descriptors for said image, comparing said descriptors with existing image descriptors corresponding to existing images in the database to determine potential duplication; and outputting an optimised database. This reduces the memory the database uses, and provides a better experience for a user browsing the database.

Preferably the image descriptors are dependent on physical characteristics of said image.

Preferably the descriptors are clustered by their multiplicity prior to comparison.

Preferably the comparing comprises determining a statistical measure of similarity.

Preferably the textual descriptors associated with said images are utilised in determining a measure of similarity.

Preferably the statistical measure is Chi squared.

Preferably the descriptors are BRISK descriptors.

Preferably the retrieved images are images retrieved from remote data source(s).

On-Demand Scraping

According to another aspect of the invention there is provided a method of dynamically updating a database on a aggregation server, the method comprising: accessing data on a remote server, the data relating to at least one item with at least one associated characteristic; updating the entry in the database corresponding to said characteristic; wherein said updating is triggered by a user interaction with said aggregation server. This maintains ‘freshness’ of items which users are, or may be, actively accessing ensuring up-to-date information.

Preferably the user interaction comprises at least one of: adding an item and/or a related item to a shopping basket, viewing a web page corresponding to said item and/or a related item, selecting/deselecting an item and/or a related item.

Proxy Order

According to another aspect of the invention there is provided a method of routing a request in a network, the method comprising: determining a geographical identifier associated with the request; determining a proxy server having a geographical identifier in dependence on the geographical identifier of the request; and routing the request to a server via the proxy server so as to mimic the request arriving directly from the initial source of the request.

Preferably, determining the geographical location of the request is in dependence on user provided information.

Preferably the user provided information comprises at least one of: a user address, billing address or delivery address.

Background Removal/Attenuation

According to another aspect of the present invention there is provided a method of image processing, for background removal/attenuation, the method comprising: determining edges of a foreground element within said image; determining a threshold level distinguishing between foreground and background; flood filling the image around said foreground element; creating a mask corresponding to the flood-filled area; attenuating the background by applying mask to original image. This allows easier for colour and/or category identification of the item indicated by the image.

Preferably the image is negated so as to aid determining the edges of said foreground element.

Preferably a Sobel filter is utilised to determine the edges of said foreground element.

Preferably the determined edges are blurred.

Preferably the blur is a Gaussian blur.

Preferably the threshold level is determined on a local level within the image.

Colour Name Identification

According to another aspect of the invention there is provided a method of determining a text descriptor of at least one predominant colour in an image, the image comprising a plurality of coloured areas the method comprising: determining the predominant colour values for the plurality of coloured areas, translating said predominant colour value into a text descriptor. This allows for a reduced set of colours to be used by a user to filter images contained within the database.

Preferably the predominant colour value into a colour name comprises determining the colour difference to at least one known colour value, the closest known colour value being elected as the colour name.

Preferably the predominant colour values and colour text descriptors are mapped onto a colour space.

Preferably the colour space is CIE lab color space, preferably CIE2000.

Preferably the closest known colour value is determined by a colour difference function determining the magnitude of the separation between the mapped predominant colour value and colour names, preferably a deltaE function.

Preferably the method further comprises attenuating the background of said image, preferably as described herein.

Preferably the size and/or number of coloured areas of the image are dynamically determined in dependence on image characteristics.

Preferably the image characteristics comprise: the homogeneity of colours in the image, the indication of the image, the resolution of the image.

Preferably thresholds are applied to certain colour values.

Preferably the method further comprises moderating the colour text descriptors, preferably by a human operator or system user.

Main Image/Category Detection

According to another aspect of the present invention there is provided a method of selecting an image most indicative of an item from a set of images, the method comprising:
(a) determining a foreground element from a plurality of images known to be indicative of an item;
(b) inputting said elements into a statistical model;

determining a foreground element from each of said set of images; determining which foreground element fits the statistical model best, selecting the image corresponding to this foreground element as being most indicative of said item.

According to another aspect of the present invention there is provided a method of determining an item type depicted by an image, the method comprising:
(a) determining a foreground element from a plurality of images known to be indicative of an item,
(b) inputting said elements into a statistical model, iterating steps (a) and (b) for at least two items; and determining a foreground element of said image,

determining which statistical model said foreground element best fits, selecting the item corresponding to this statistical model as being shown by said image.

Preferably the image forms part of a set of images and the method comprises selecting the image from the set of images corresponding to this foreground element as being most indicative of said item.

Preferably each item corresponds to a particular category or sub-category of item.

Preferably each item has a separate statistical model.

Preferably the item is an item of clothing, jewelry, footwear, luggage or accessory.

Preferably the set of images correspond to a plurality of different views of said item.

Preferably the statistical model is a random forest model.

Preferably the plurality of images known to be indicative of an item are selected based on rules for a particular item governing the most indicative view of said item.

Preferably said rules comprise at least one of: most common view, most informative view, most flattering view.

Non/Member Checkout

According to a further aspect of the invention, there is provided a method of user authentication, comprising the steps of: receiving, from a user, user data at a first entity; determining in dependence on the user data the existence of a related user account at a second entity; and in the absence of a related user account either:
a) generating a new user account, in dependence on the user data, at the second entity; or
b) requesting, from the user, further user data, relating to a valid user account at the second entity.

Preferably, the existence of the related user account is determined at the first entity.

Preferably, the method further comprises the step of forwarding the user data from the first entity to the second entity and determining the existence of the related user account at the second entity.

Preferably, the method further comprises the steps of determining in dependence on the user data the existence of related user accounts at a plurality of further entities; and in the absence of related user accounts either:
c) generating new user accounts, in dependence on the user data, at the further entities; and/or
d) requesting, from the user, further user data, relating to valid user accounts at the further entity.

Preferably, the user data comprises at least one of: usernames: emails; passwords; payment data; user billing and shipping addresses.

Preferably, the method further comprises the step of generating a password for at least one new user account.

Preferably, the method further comprises the step of submitting a transaction order from the first entity to the second or at least one further entity.

According to yet another aspect of the invention, there is provided a method of facilitating a user transaction, comprising the steps of: receiving, from the user, at a first entity, constituent elements of a transaction to be conducted at a second entity; determining, in dependence on the elements of the transaction, the necessity for a user account at the second entity in order to facilitate the transaction; generating, at a first entity, a notification in the event a user account is determined to be necessary.

The invention also provides a computer program and a computer program product for carrying out any of the methods described herein and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein and/or for embodying any of the apparatus features described herein, a method of transmitting such a signal, and a computer product having an operating system which supports a computer program for carrying out any of the methods described herein and/or for embodying any of the apparatus features described herein.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

Furthermore, features implemented in hardware may generally be implemented in software, and vice versa. Any reference to software and hardware features herein should be construed accordingly.

Further features of the invention are characterised by the dependent claims.

The invention extends to methods and/or apparatus substantially as herein described with reference to the accompanying drawings.

These and other aspects of the present invention will become apparent from the following exemplary embodiments that are described with reference to the following figures in which:

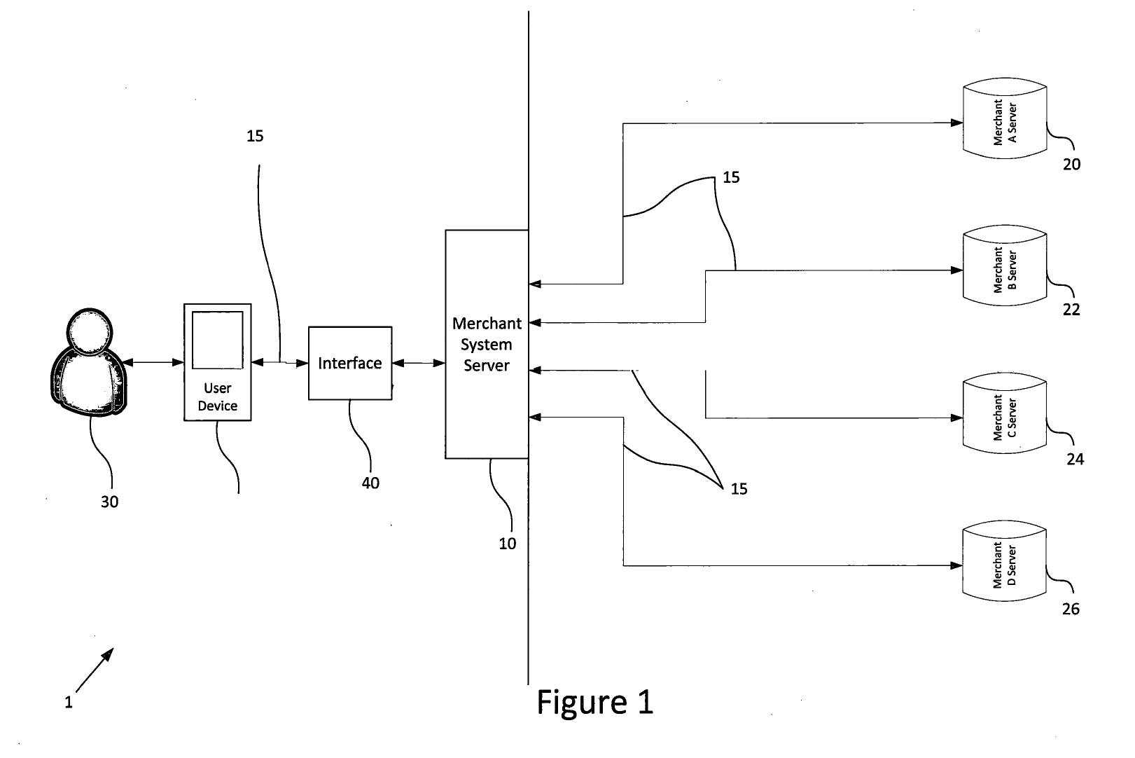

FIG. 1 shows the aggregating system or service provider in overview;

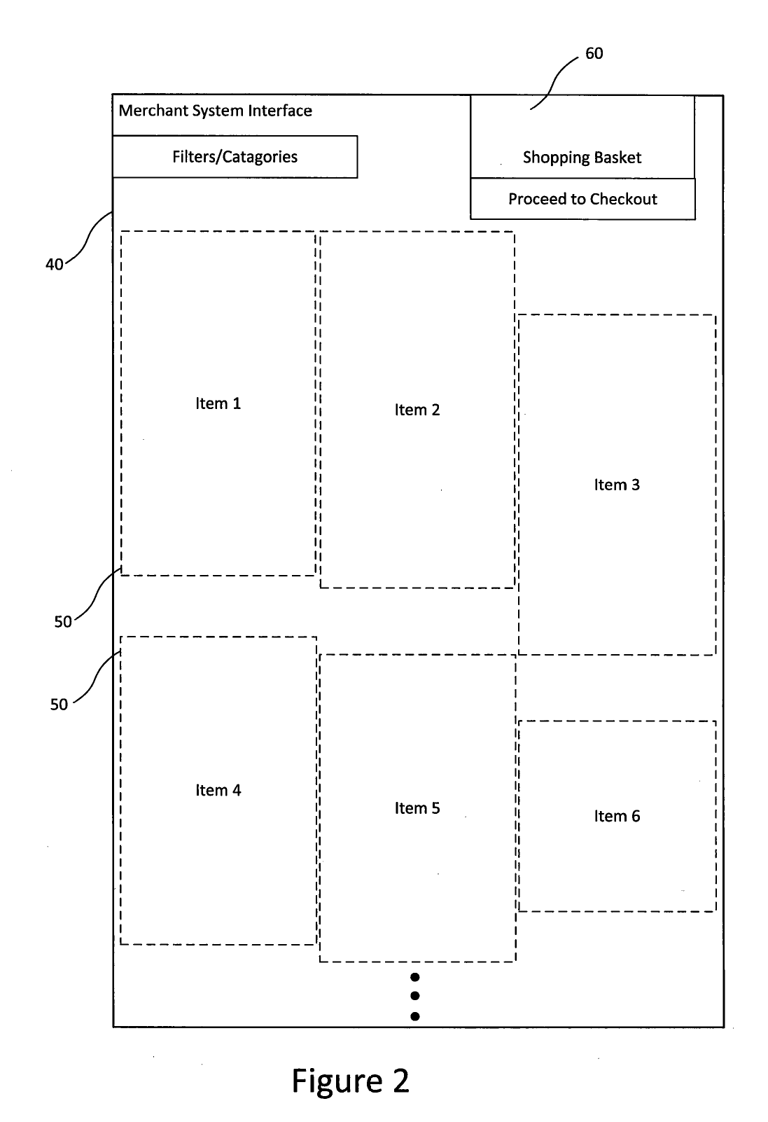

FIG. 2 shows the product selection user interface in overview;

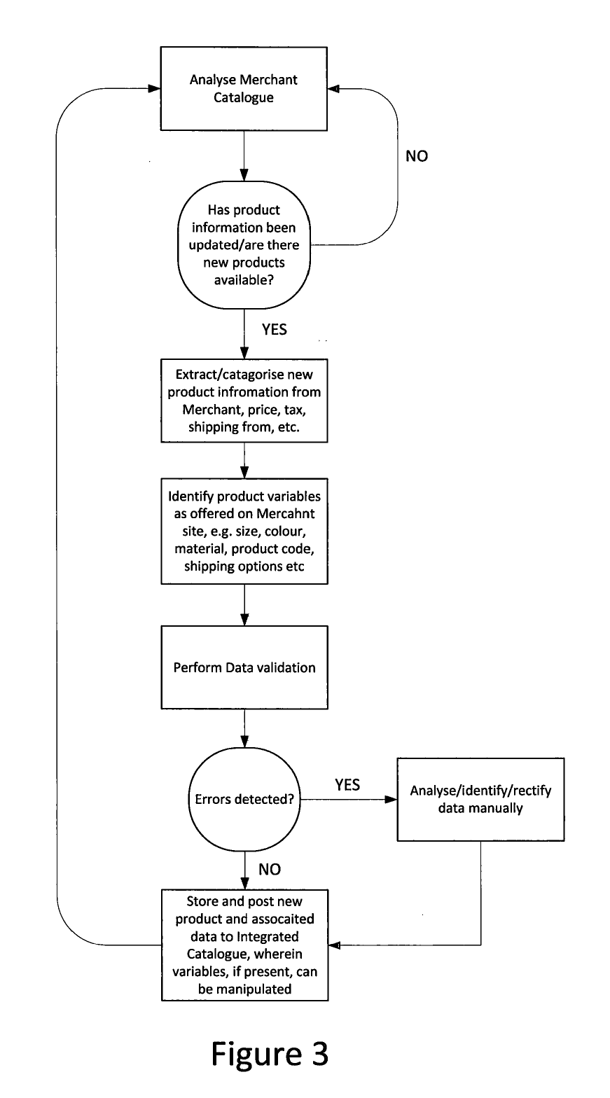

FIG. 3 shows the interface update process;

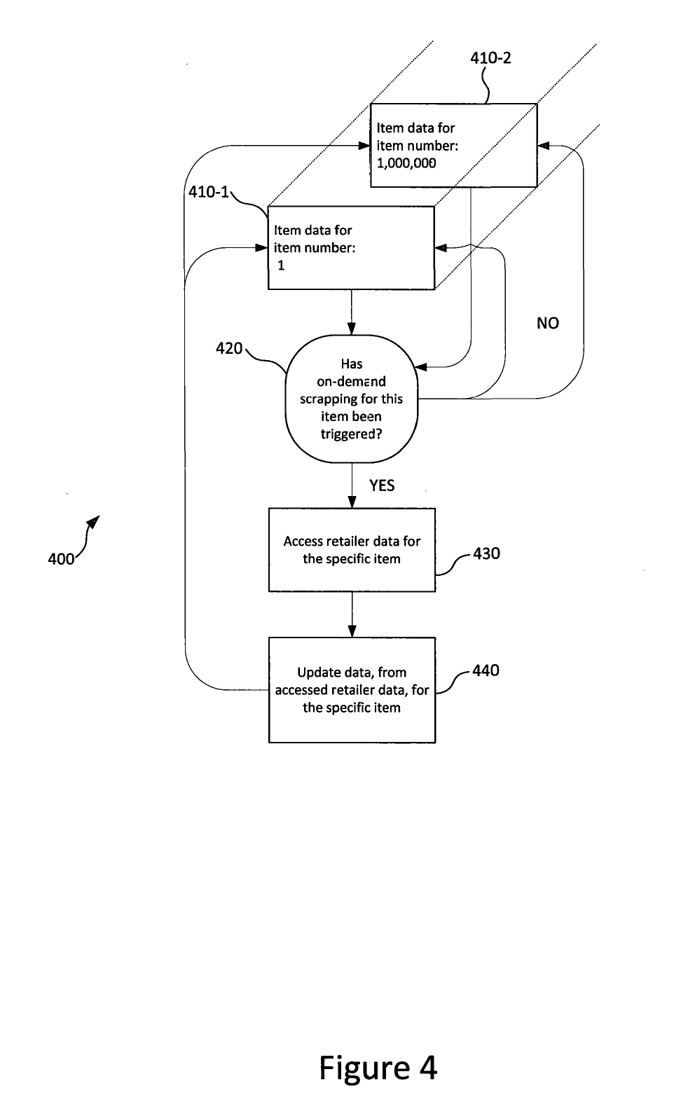

FIG. 4 shows a process for “on-demand” scraping;

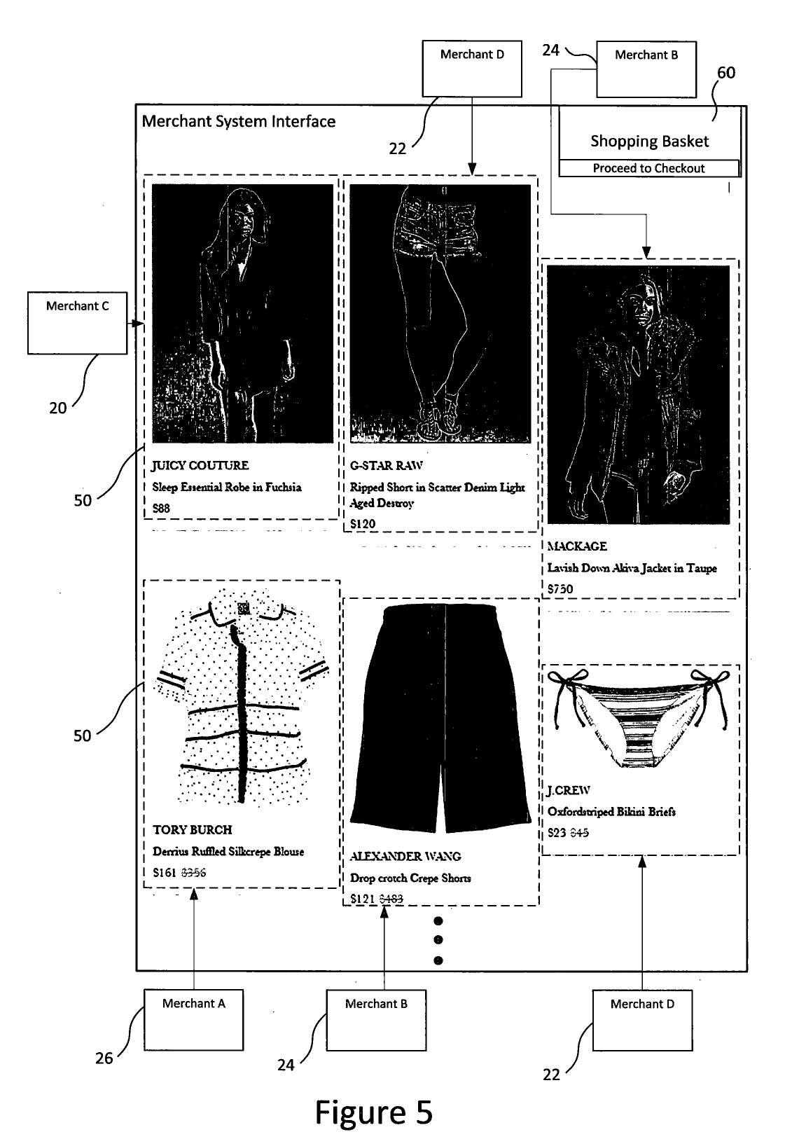

FIG. 5 shows the interface populated with product data;

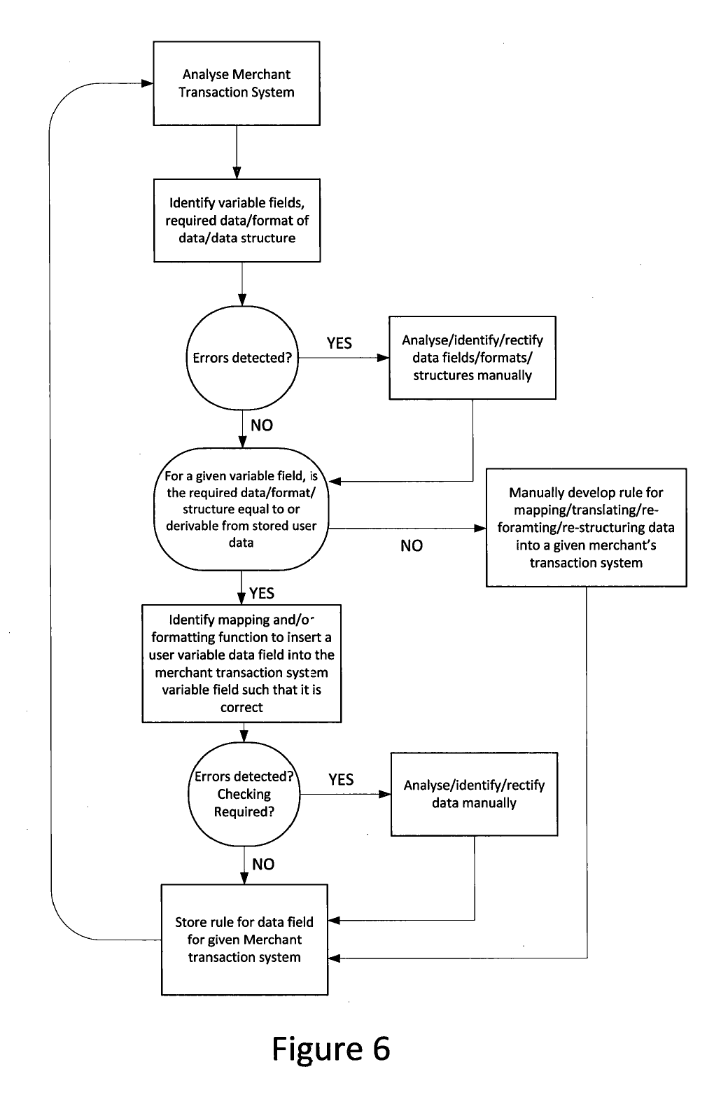

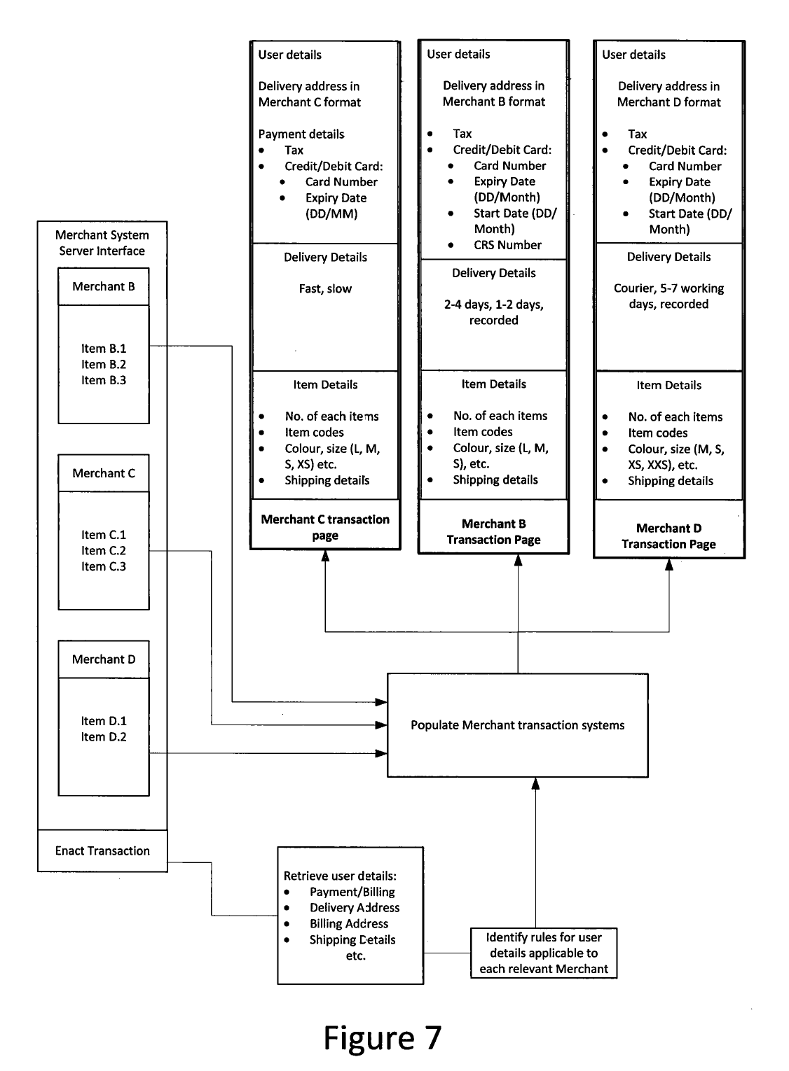

FIGS. 6 and 7 show the merchant mapping process;

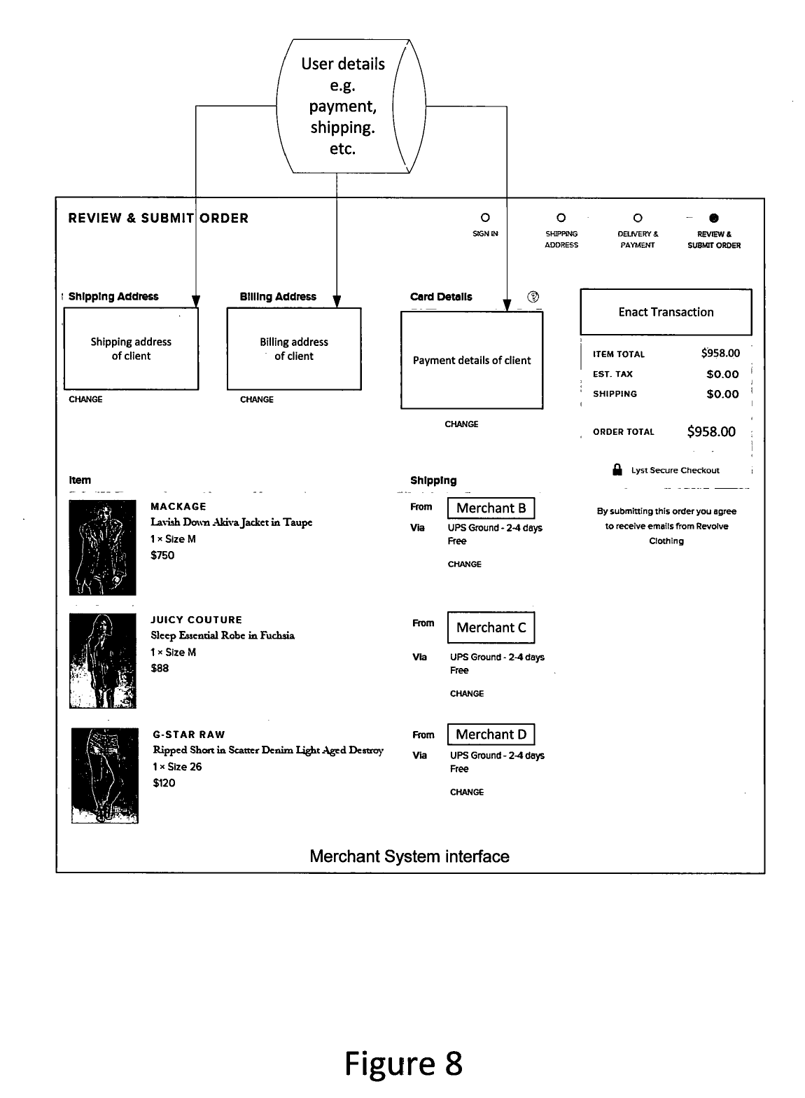

FIG. 8 shows an example checkout screen;

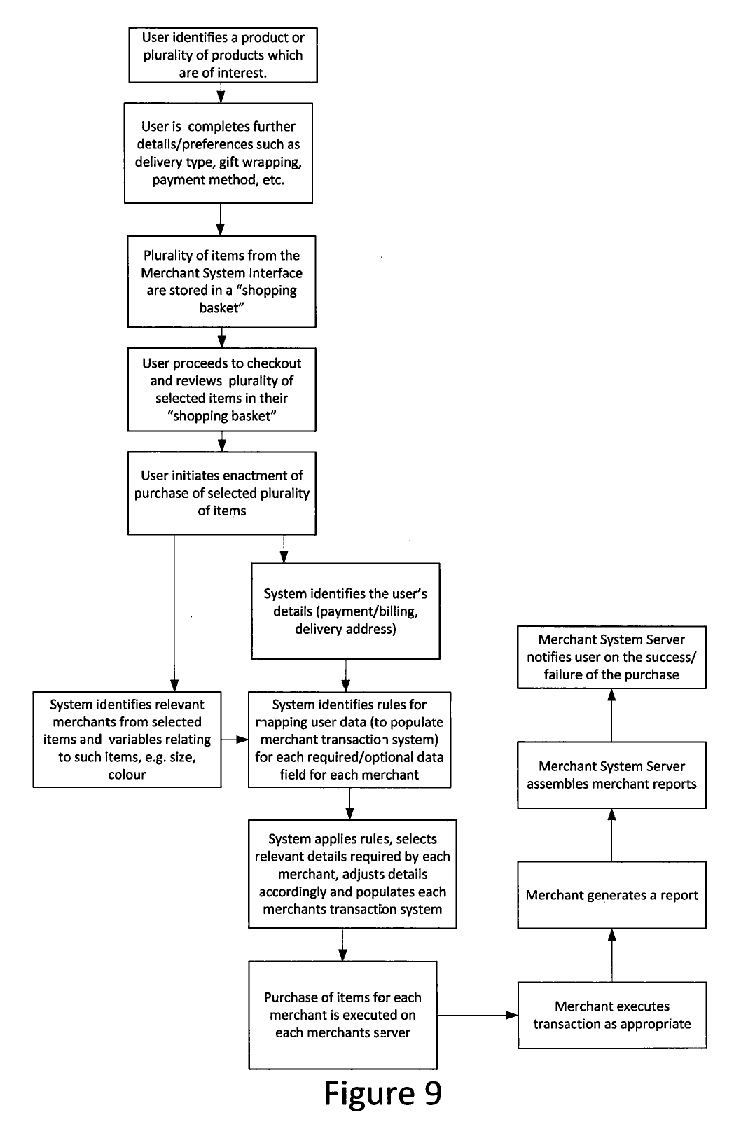

FIG. 9 shows a typical user interaction with this “integrated checkout” system;

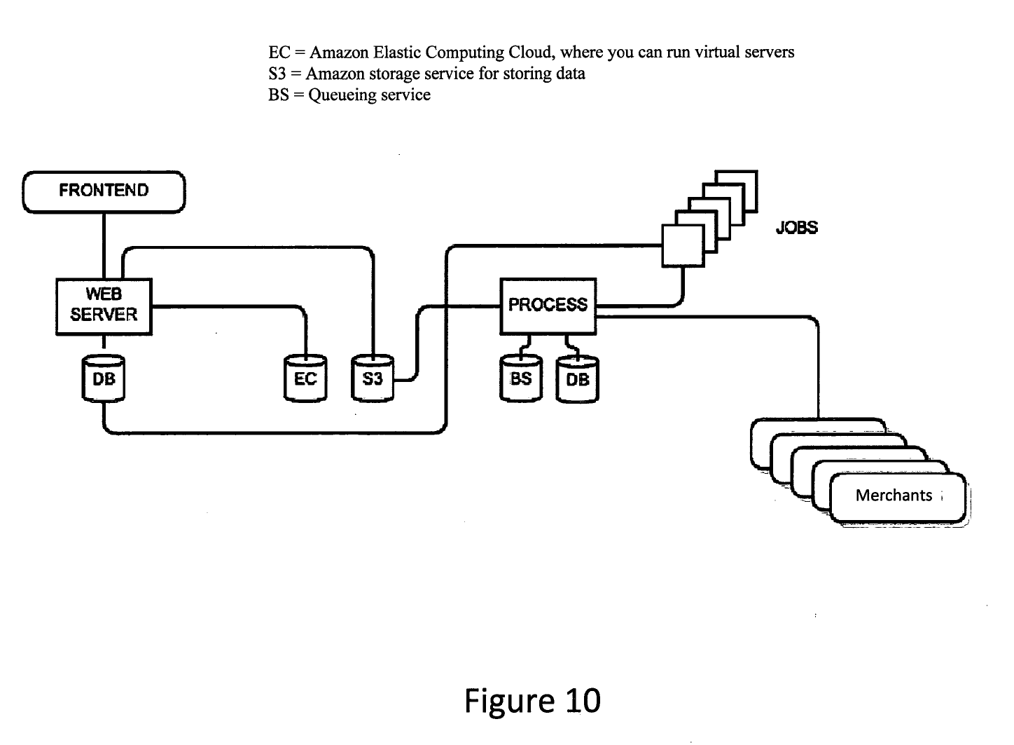

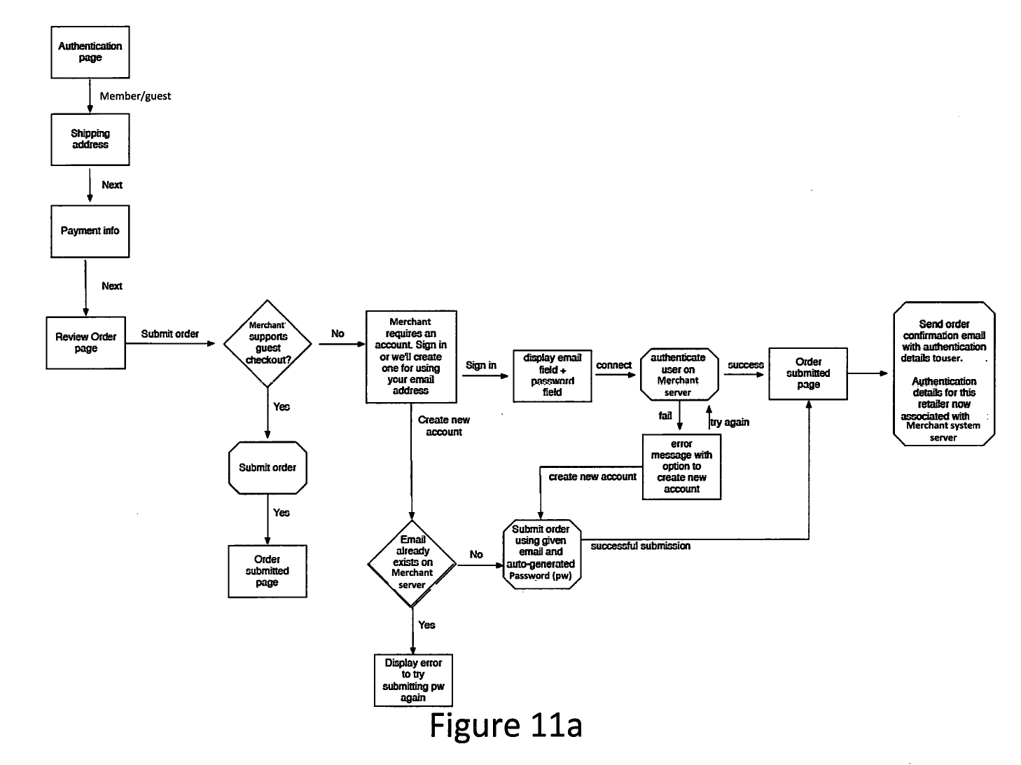

FIG. 10 shows further aspects of the system architecture;

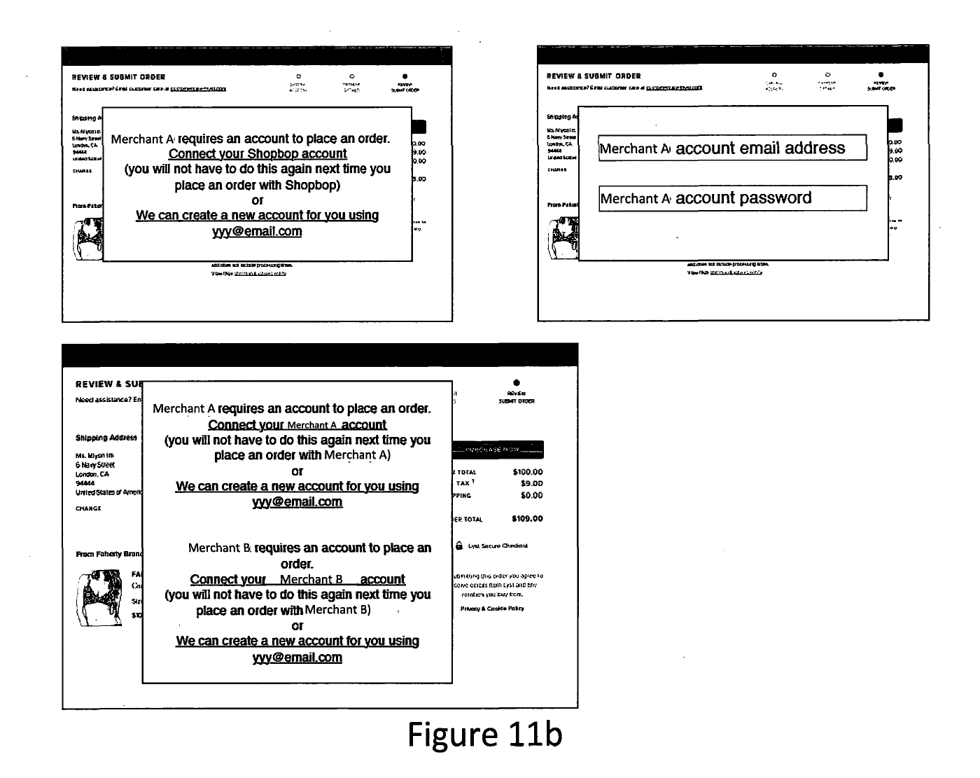

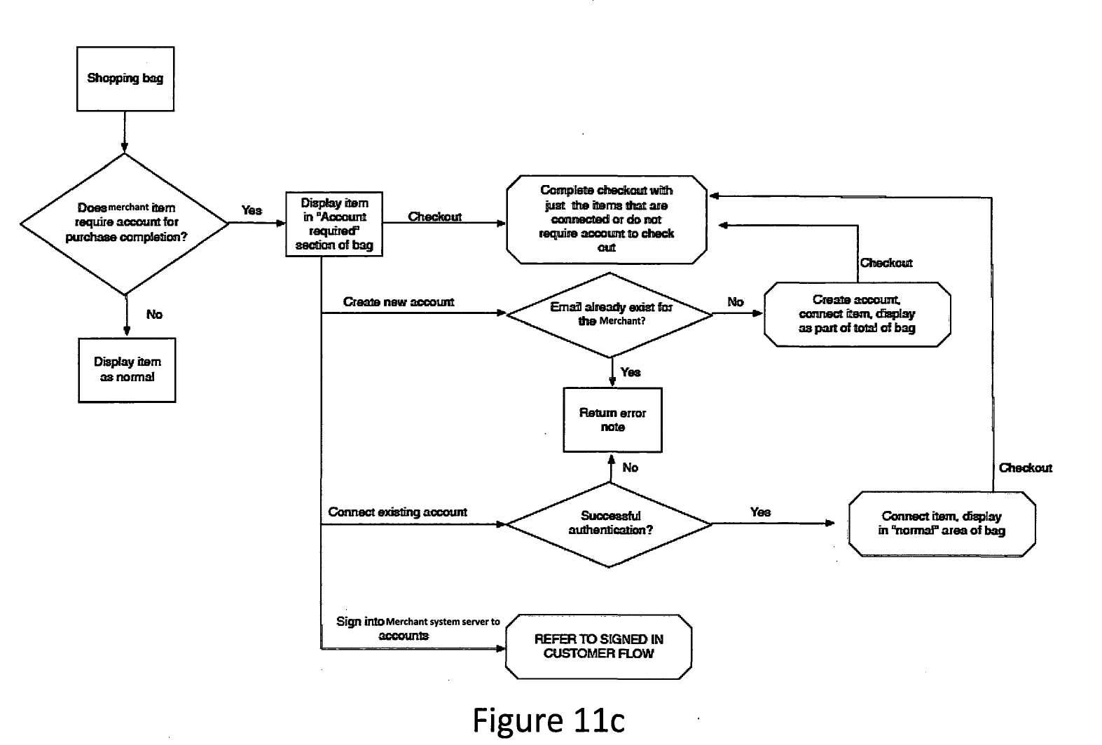

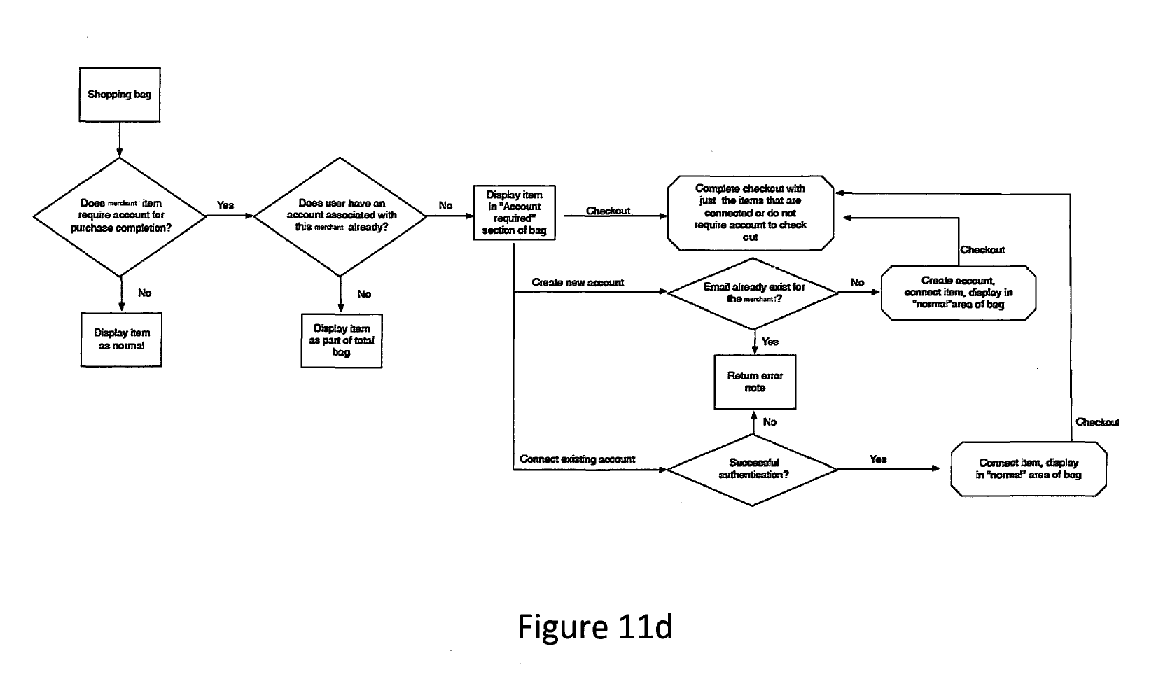

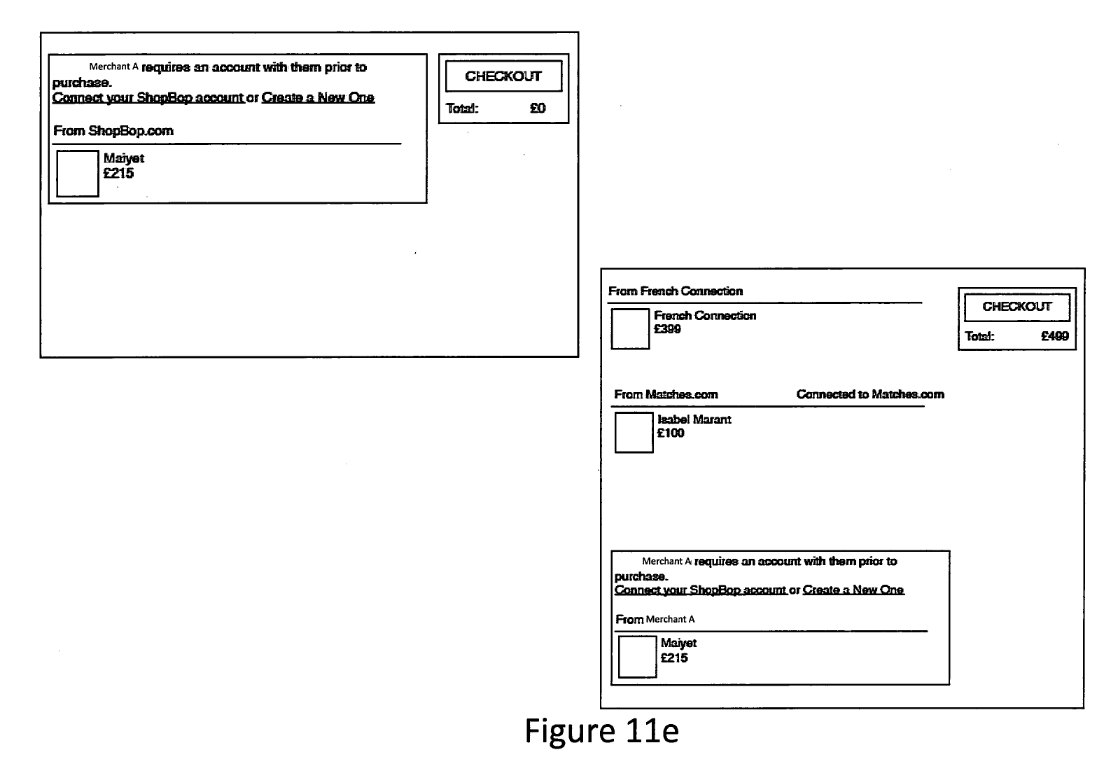

FIG. 11 show methods, along with associated user interfaces, of accommodating user transactions in dependence of whether a user holds a registered account;

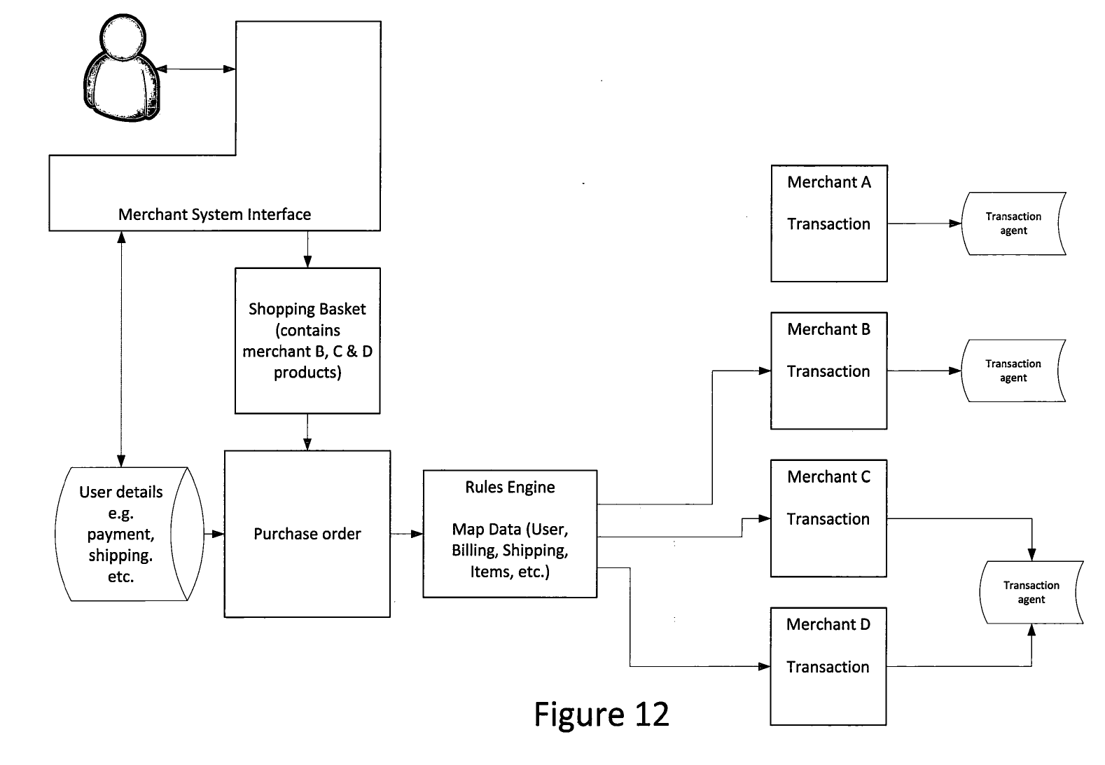

FIG. 12 shows another overview of the system;

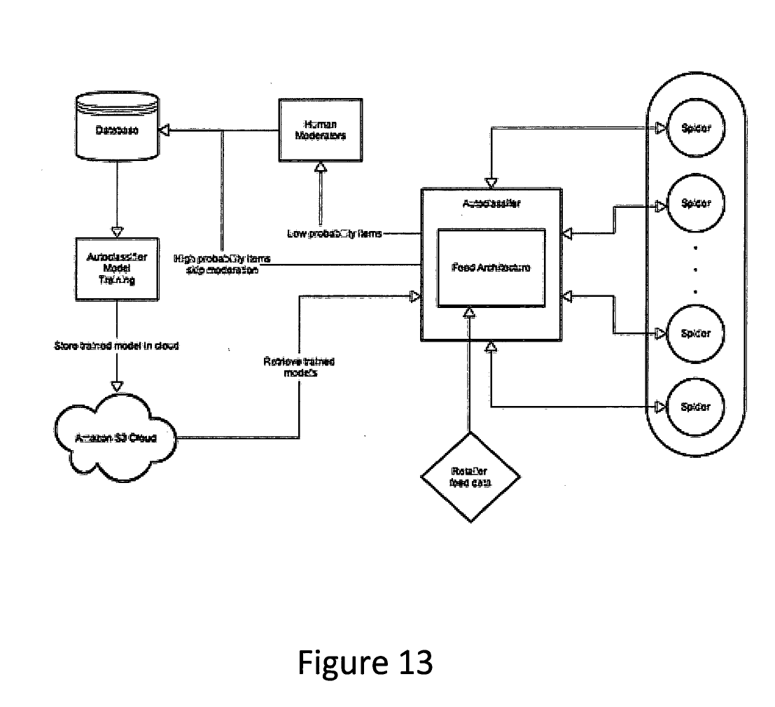

FIG. 13 shows an overview of the ‘autoclassifier’ classification process;

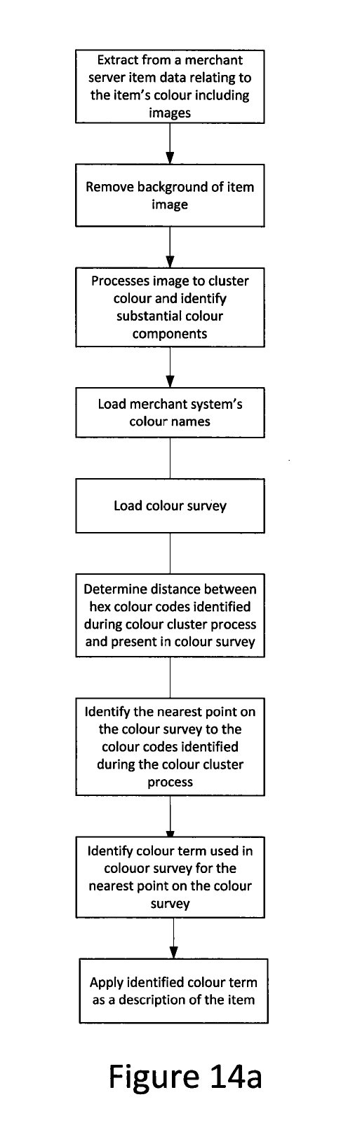

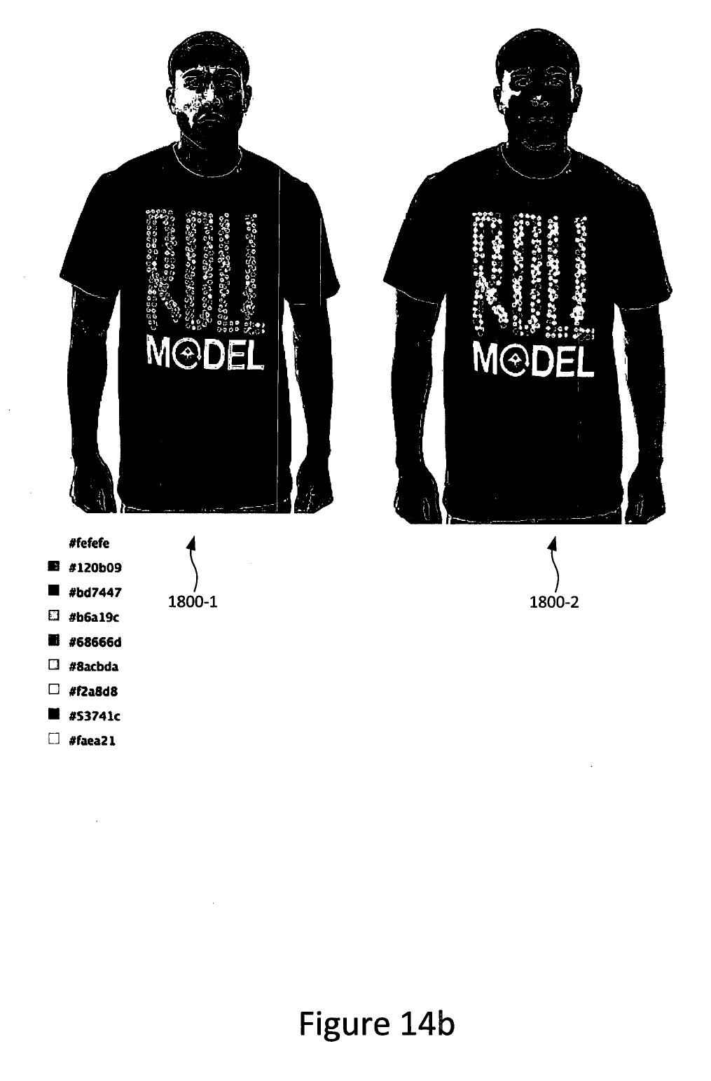

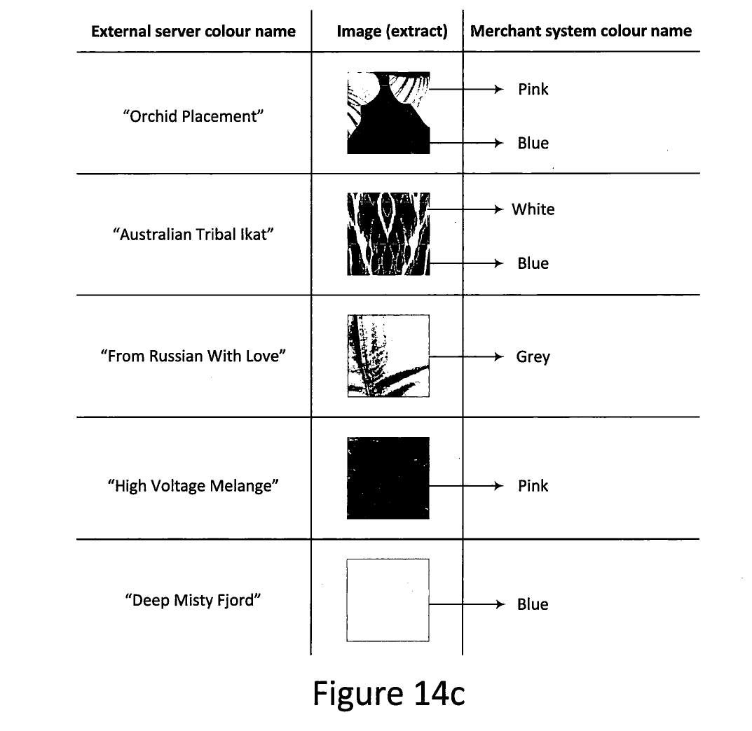

FIG. 14 show a process of identifying colour names from images, along with outputs of this process;

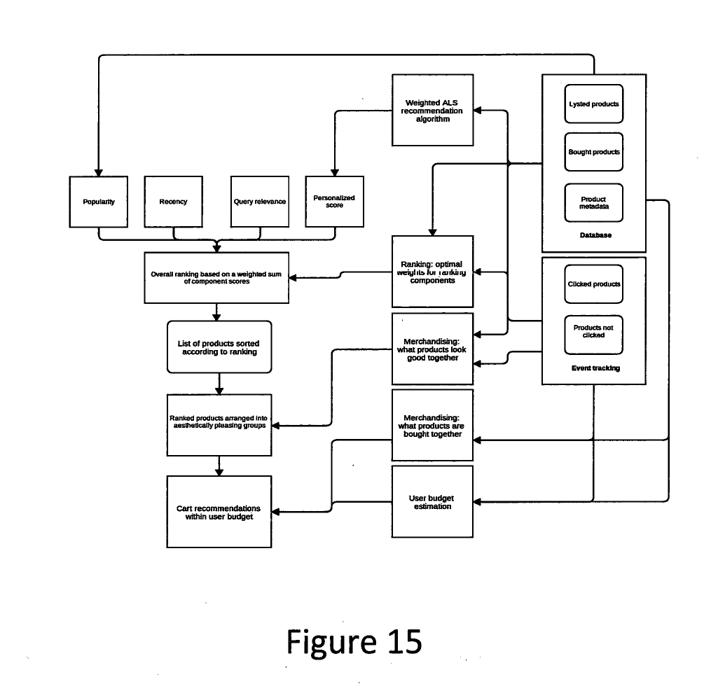

FIG. 15 shows on overview of the recommendation process, as performed by the recommendation engine;

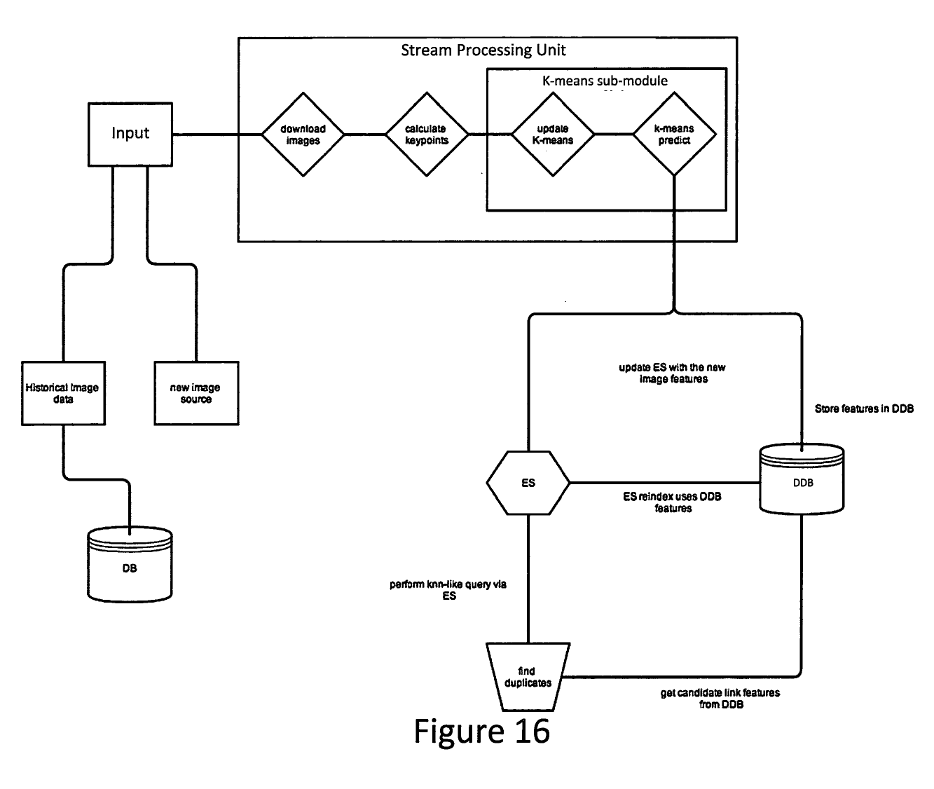

FIG. 16 is a schematic of the architecture of the aggregating system as used for “de-duplication”;

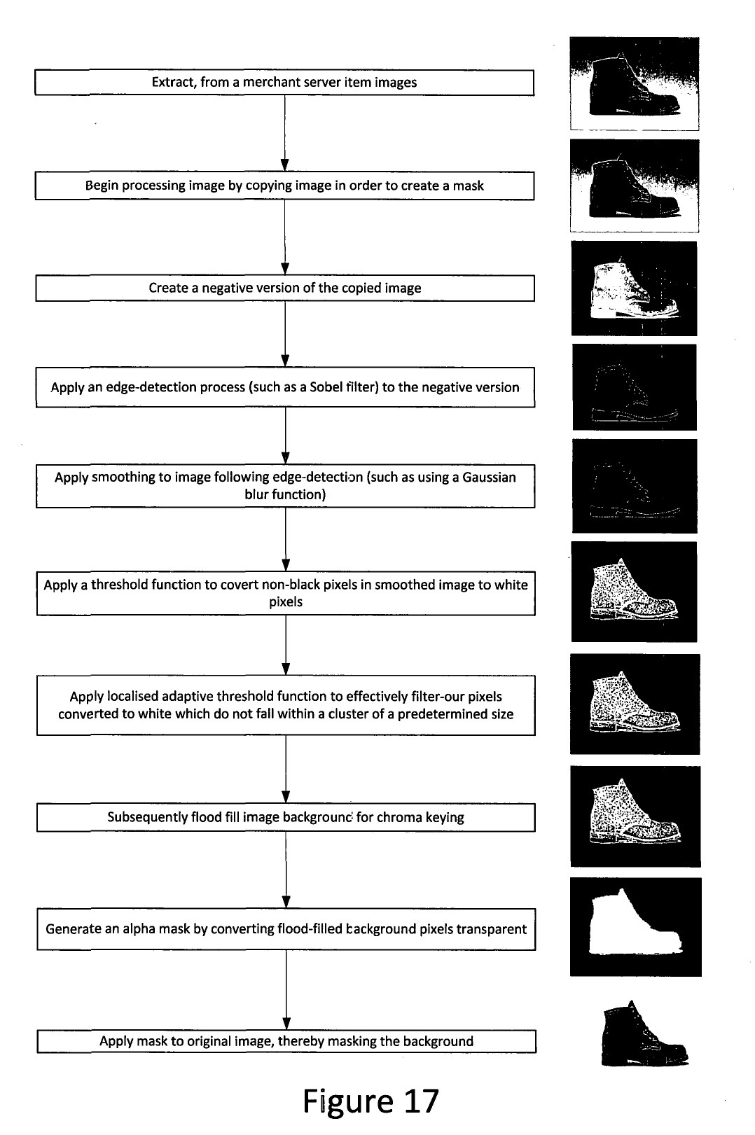

FIG. 17 shows a method of removing background elements of an image, along with associated outputs;

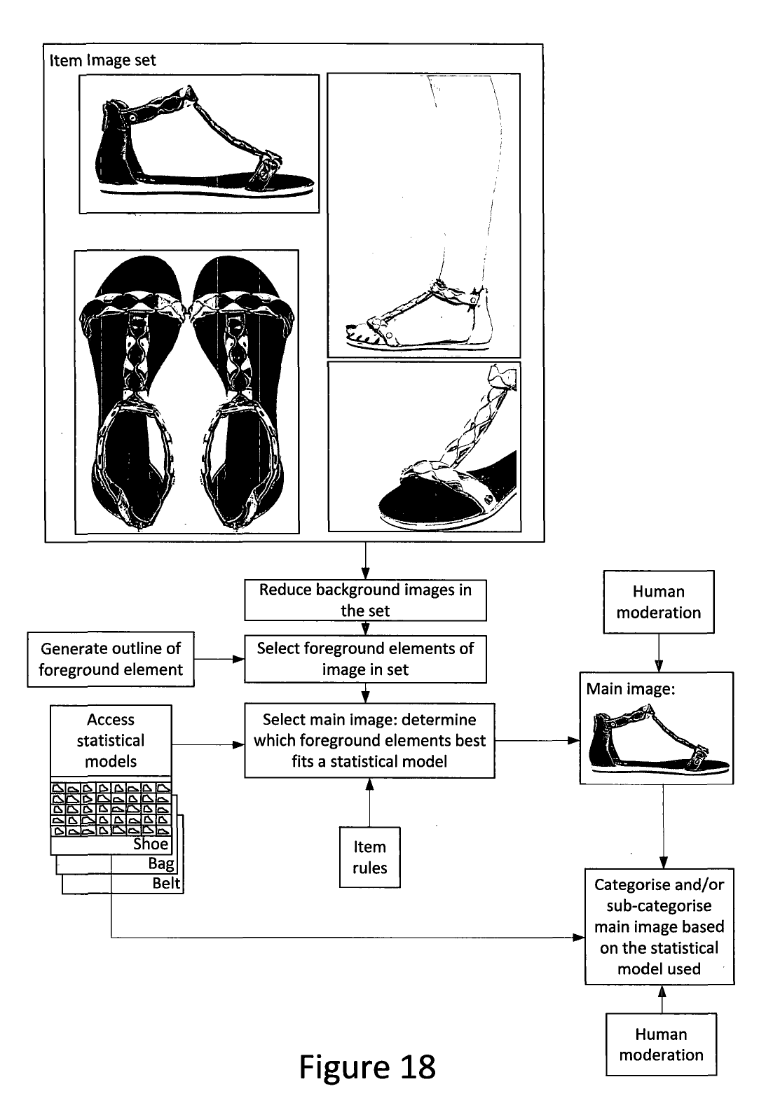

FIG. 18 illustrates a method of identifying a “main image” from a set of images; and

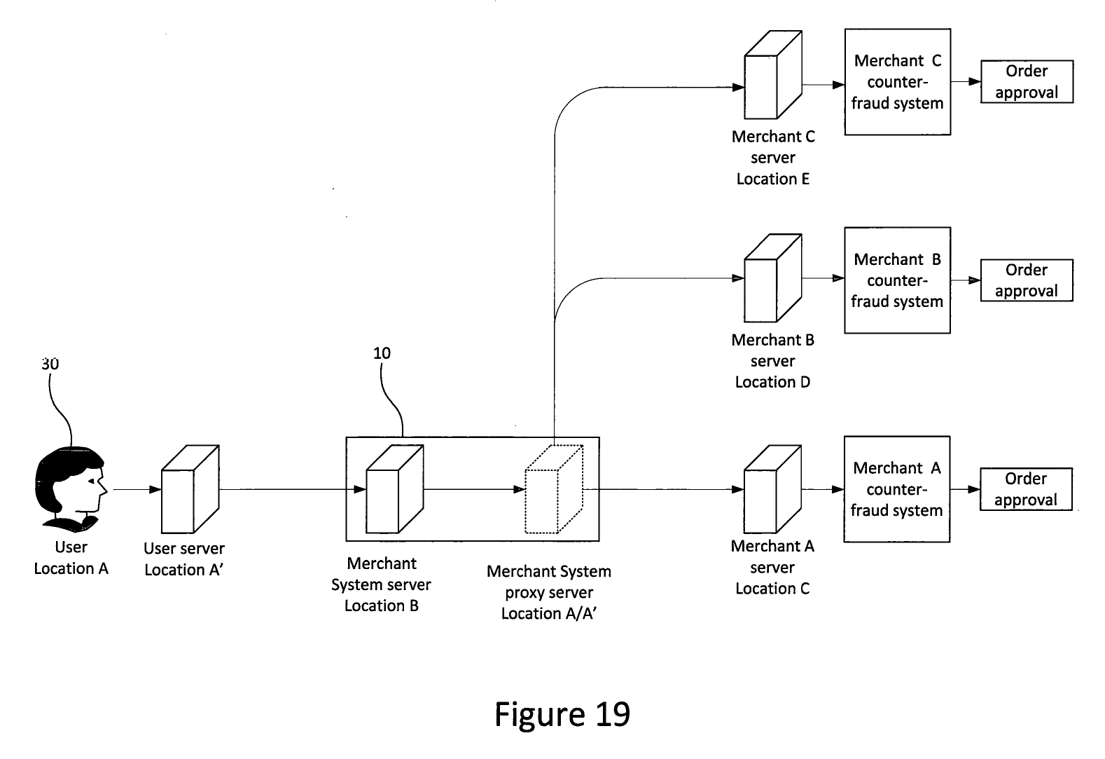

FIG. 19 shows a network arrangement of the aggregating system for overcoming counter-fraud systems.

### OVERVIEW

FIG. 1 shows the aggregating system (or “merchant system”) or service provider 1 in overview. Aggregating system server 10 (preferably, herein also referred to as the “merchant system server”) is shown in communication over a computer network 15 with a plurality of merchant servers 20, 22, 24, 26 each representing the (typically web) “front-end” of their respective merchant on-line electronic commerce facility.

The merchant system may be implemented on a standard computer hardware/software platform, for example running Linux or a similar operating system, with Apache web server, MySQL database and with software components written in, for example, python or a similar language with various libraries to handle the HTTP protocol (python-requests)—commonly referred to as a LAMP package.

Aspects of the merchant system may also make use of various cloud computing facilities and services, such as Amazon Elastic Computing Cloud (EC2), for running virtual servers, S3 (Amazons storage service for storing data) and a queuing service such as BS. Elements of e-commerce platforms, for example the open-source Magento, may also be used.

A user 30 is shown accessing merchant system server 10 via user device 30. This access may be via the same computer network 15 or via a different network, say a 3G or 4G telecommunications network in the case of a mobile device.

Merchant system server 10 presents information to user device 30 via a user interface 40 such as a webpage or, particularly for mobile devices, via a dedicated application or app.

FIG. 2 shows the product selection user interface in overview. Interface 40 represents to user 30 an aggregation of product or merchandise data. Interface 40 presents the product information in a categorised form for the ease of the user 30, effectively shielding user 30 from the existence of the various merchant servers 20, 22, 24, 26, and the specific details of their respective merchant on-line electronic commerce facilities. Categorisation may be via algorithm, at least initially, with uncertainties referred to human moderators.

In some embodiments, user 30 may also ‘subscribe’ to or ‘follow’ particular categories, for example from a particular merchant or producer. Optionally, the data feeds and/or ‘crawling’ or ‘scraping’ activities are tailored according to the categories being followed by the user 30. A user may also follow another user.

FIG. 3 shows the interface update process. The product data is acquired, preferably at regular intervals (typically every few hours for timeliness), from the merchant servers 20, 22, 24, 26, by means of data feeds from the merchant servers 20, 22, 24, 26, and/or via data ‘crawling’ or ‘scraping’ their associated websites by software 'bots. Additional processes may be used to check the aggregated data for accuracy.

Generally, the scraping process involves remote access of the retailer website by a software agent resident on the merchant system. The retailer website is traversed by the agent according to rules describing for the agent which hyperlinks of the website to follow.

In more detail, the update process proceeds as follows:
1. For a given merchant server (20, 22, 24, 26), the merchant system server 10 assembles product information. This can be done by any means, such as web crawlers, spiders, automatic indexers, monitoring software, etc.
2. The merchant system server 10 inspects the collected data from a given merchant server and determines whether new items have been uploaded or details, such as, images, price, colour, stock levels, sizes, availability etc. have been altered.
3. If no new items have been found, nor any item details changed, the system loops to Step 1.
4. If item details have been amended or new items added, then pertinent new information relating to these items is extracted from the merchant server.
5. The system server 10 analyses and collates the extracted information to determine data structures for items, categories, variables (such as user selectable preferences, including size, colour, etc.) and accommodate these such that they remain variable, able to be manipulated by a user using the merchant server system interface 40.
6. The extracted data and determined variables are validated, for example a regimen for preventing a size field containing a figures, or an item manufactured in Europe adhering to European sizing standards and units.
7. If data validation indicates that an error has occurred during extraction of the data a notice is generated indicating that manual or further analysis is required to correct data and the matter referred to a human moderator. Once errors have been corrected, the system can proceed to Step 8.
8. If data validation indicates that no error has occurred during extraction the new information can be uploaded to the merchant system server 10 and interface 40 for visibility to users. Users can now interact and purchase these items as described above.
9. The system shown in FIG. 3 will loop back to Step 1 and continue to search for updates.

Steps 1 to 9 are performed for a plurality of merchant systems, e.g. 20, 22, 24 and/or 26.

The frequency of crawling a particular retailer website may be several times a day for large or popular retailer, in order to provide timely information of changes and new items.

In some embodiments, hashing functions may be used to determine whether a change has occurred since the previous crawl.

Some key items, such as price, may be monitored more frequently than others.

In some embodiments, the crawling agent pays particular attention to determining product availability or stock information. This may involve the agent interacting with the retailer website, for example accessing the site as a dummy user (potentially via a provided guest account) to check actual stock levels by placing a dummy order, say by adding the item to a shopping basket. More detail relating to automated stock checking is provided below.

Generally, the process involves attempting to disassemble the retailer webpage semantically, effectively understanding the meaning of the various page elements. Some of this may be accomplished by context, for example determining item category or ‘gender’ from sizing information. For example, a size parameter of “42” may refer to a shoe, whereas “X” is unlikely to. Such information may also be used in the weighting of probabilities in the algorithmic classification process, described below.

In some embodiments, raw item information may be provided by a retailer as a separate data feed. In some instances this may require separate determination of the most suitable product image, for example by analysing the retailer web page in dependence on the item data obtained from the feed.

With several sources of potentially conflicting information per retailer, embodiments preferably assume the public face of the data—as presented on the retailer website, viewable by the general public—is correct.

Processes may also be run on the scraped data before it is uploaded to the merchant system database. This is described in more detail below.

FIG. 4 shows a process of scraping individual products (herein referred to as “on-demand scraping”) 400 instead of all products on a specific retailer (also referred to as “merchant”) website. “Normal” scraping recursively follows links on a merchant website and extracts product information out of the visited pages; this process is scheduled on an on-going basis. However, where the item universe (referring to the complete range of items listed on the merchant system server 10—comprising a plurality of items with associated data) is large (for example, over one million, five million, ten million or fifteen million items), full scraping is not effective enough to ensure efficient updating of item data (so as to ensure “product freshness”). On-demand scraping solves the aforementioned problem by scraping and thus updating data for a specific item only upon triggering for scraping to be carried out, which would otherwise not occur until a later point.

The item universe comprises data for the entirety of all items stored in the merchant system server 10. For example, data is stored for an item nominally referred to as “item number 1” 410-1 and “item number 1,000,000” 410-2 of the range of items listed on the merchant system server 10.

A process to detect whether scraping for a specific item has been triggered is used 420. Triggers may be item-specific insofar as a certain trigger maps onto a certain item or group/list of items. If a trigger is detected by the merchant system server, then a scraping command is generated in order to update the data for the item to which the trigger applies. Triggers include, for example, user actions with the merchant system server, including a user adding an item to a basket (hence triggering the data-scraping process for items within the basket), a back-in-stock alert (for example, based on the merchant system identifying a list of items recently) might refresh all items referenced in the alert (in which case items are updated before sending the item alert are ordered by users).

Once a trigger has been detected, the (merchants′) external server(s) are accessed 430 in order to scrape data regarding the item or items to which the trigger refers. The data from the external server(s) is used to update the data, held on the merchant system server 10, for the item or items for which the trigger refers 440; after this step the process 400 loops. If no trigger is detected in step 420, then the process 400 also loops.

The method described with reference to FIG. 4 is achieved by, for example, running a modified version of the Scrapy code in a way which allows all external servers (or websites, which may number over 500) to be refreshed on an item-by-item basis following a trigger.

Generally, new items—those that have never previously entered the item universe—are scraped using a scheduled scraping process.

For items identified as having come back in stock by the merchant system, alerts are sent out to users for marketing providing a list of links to these items (typically discovered by the “normal” scraping process). On-demand scraping is run on this list of links to ensure that the links reflect items that are indeed in stock; if such a link turns out of be out-of-stock (despite being flagged as being in stock), then the link is evicted from the list of items to send out as part of the alert.

FIG. 5 shows the interface populated with product data.

The selection by user 30 of an item 50 for purchase involves the user interacting with interface 40, allocating the item to a virtual “shopping basket” 60.

The selection of items to display to the user may be generic or themed initially (or when interacting as a ‘guest’ user), but with increasing interaction with the interface and/or in dependence on information gleaned from repeated interactions as a ‘registered’ user, a profile for the user may be generated, and the displayed items may be recommended by the system. This process is described in more detail below.

Purchase of the item 50 involves the user 30 proceeding via interface 40 to a “checkout” stage.

Typically, each of the various merchant servers 20, 22, 24, 26, and their respective merchant on-line electronic commerce facilities will have distinct and different purchase procedures. The user 30 is effectively shielded from these via interface 40.

The system 1 provides an “integrated” checkout process.

FIGS. 5 and 6 show the merchant mapping process. Customised retailer rules are used to map the purchase processes (which typically require the completion of one or more web forms with information by the purchaser) of the various merchant servers 20, 22, 24, 26, and their respective merchant on-line electronic commerce facilities onto a common data structure.

The merchant mapping process typically involves analysing the web forms used by the respective purchase processes, which may initially be a task performed manually. Once the mapping has been determined, a purchase at particular merchant may be accomplished by a spider process activated by the purchaser posting the appropriate purchaser information (previously acquired from the user), handling any issued cookies to store session information etc without detailed user intervention. With a sufficiently detailed analysis and mapping of a merchant purchasing process, the spider process is robust enough to handle all the various types of fields including taxes, shipping and totals.

FIG. 7 shows an example checkout screen.

A typical user interaction with this “integrated checkout” system will now be described, in this example in a fashion environment.

### Integrated Checkout Task Flow

FIG. 8 shows a typical user interaction with this “integrated checkout” system.
1. Having selected a product/item, the customer selects a size of item (if the product is a sized item) and then selects the “Buy Now” button.
The available sizes are fetched from the retailer's own product page.
2. The customer is prompted to sign in as a member of the system or to continue as a Guest.
Returning customers are also prompted to sign in for security purposes as their payment details are saved for faster checkout in the future. For return purchases by members, the customer only experiences steps 1, 2, 6, 7, 8.
3. If this is a first time purchase or a Guest Checkout, the customer is displayed with a form to enter in their shipping and billing addresses. They then select “Proceed”.
4. Optionally, the customer is then given the option to select the Cheapest or Fastest shipping options available.
Although the specific retailer may have more options available, for simplicity only the Cheapest and Fastest options are displayed. It is displayed with the shipping method type, estimated shipping time, and cost.
5. Before proceeding, the customer enters their payment method details: Credit card number, Expiration date, and CVC (security number).
These details are securely saved for members for faster checkout in the future (typically, the CVC is not saved or stored, in compliance with regulations and/or best practice methodology). They can change the payment method from the Order Review page.
6. On the final Order Review page, the customer has an opportunity to check all the details of their order: Product, size, price, shipping option, payment method, shipping and billing addresses.
7. The customer then selects “Submit Order”.
At this point the backend assembles all of the relevant data (customer details, product details) and submits it to the retailer's own website. This process is hidden from the customer and conducted in the background.
8. If it is successfully submitted, they are shown a page confirming that the order has been submitted, along with a summary of their order. The customer is advised that they will soon receive further status of their purchase from the system and from the Retailer in the email that they submitted during checkout.
If the order is unsuccessfully submitted due to a system error on the system, the customer will receive an email notifying them of this status.
If the order is successfully submitted, the customer receives one email from the system and one from the retailer confirming this status.
As the order has been submitted directly to the retailer, the order fulfillment process and experience with the retailer is not distinguishable from an order placed on the retailer website itself.

Thus the purchase order is fulfilled by the system 1 on behalf of the user 30 without their having had to interact directly with the merchant servers 20, 22, 24.

Effectively, the merchant system handles the card payment on behalf of the retailers, with the retailer remaining the merchant of record. This may simplify integration of retailer systems with the merchant system.

In practice, the merchant system presents expected transaction details to the user, using calculations of certain aspects such as sales taxes. The actual transaction is processed typically a few seconds after the user decides to proceed. Preferably, the or each item price is checked several times before the transaction proceeds, typically each time an item is added to the basket.

```
Example pseudo-code for implementing such a process is as follows:
“““
Icon integrated checkout service Processor class
”””
class Processor( ):
  def run(params):
  # prepare order on retailer's service
  retailer_data = prepare(order_data, params)
  # validate prepared data
  validate_items(order_data, retailer_data)
  validate_amounts(order_data, retailer_data)
  # execute order
  order_summary_data = checkout(order_data, params)
  # validate purchase summary
  validate_order(order_data, order_summary_data)
  # finalize order
  finalize(order_data, order_summary_data)
  #notify
  notify(OK or Error)
  return OK
  def prepare(order_data, params):
  # submit items
  retailer_data += submit(order_data.items, params)
  #submit address
  retailer_data += submit(order_data.address, params)
  #submit shipping
  retailer_data += submit(order_data.shipping, params)
  return retailer_data
  def validate_items(order_data, retailer_items_data):
  if order_data.items == retailer_items_data.items:
    return OK
  else:
    return Error
  def validate_amounts(order_data, retailer_amounts_data):
  if order_data.amounts == retailer_amounts_data.amounts:
    return OK
  else:
    return Error
  def validate_order(order_data, retailer_order_data):
  if order_data.order == retailer_order_data.order:
    return OK
  else:
    return Error
  def checkout(order_data, **kwargs):
  return execute(order_data)
  def finalize(order_data, order_summary_data):
  save(order_data)
  save(order_summary_data)
  return OK
  def notify(status):
  if status == OK
    send(email_thank_you)
  if status == Error
    send(email_order_failed)
  return OK
```

FIG. 9 shows further aspects of the system architecture showing components of the checkout process. Referring to the figure:
EC: ElasticCache, is an in-memory key-value storage system based on memcached. This is use by the Webservers to send “messages” to the Processors
S3: Object storage service, such as that provided by Amazon. This is used to store user credit card details in the form of encrypted keys, individual keys per user. These in turn are used by the Processors to send requests to the retailer on behalf of the user.
Processors: the individual processors tailored to the website of the individual retailers and that, when sent a specific “message” from the web server, will unencrypt the credit card details in the database DB, using the encrypted keys in S3, and send a request to the Retailer by spawning a job.
BS: Beanstalk, a queue used by the different systems to communicate, via messages in the queue, in an asynchronous manner.

### Multiple Merchant Integration

In the preceding embodiment, customers were able to only purchase one item at a time from one retailer.

Based on similar underpinnings as described above, further embodiments extend the system 1 to allow for the simultaneous purchase of multiple items from multiple retailers.

In particular, a multi-merchant or multi-vendor shopping basket is presented, which enables higher order values or higher value orders as well as the opportunity to engage with multiple retailers with a single order.

What appears to the user as a single multiple-item order over multiple retailers may nevertheless be treated by each of the constituent retailers as an individual order (who may be unaware of the other items making up the multiple-item order) and be processed by each retailer separately.

The user an integrated buying platform and does not see online the individual retailers—but does receive individual invoices.

FIG. 10 shows another overview of the system.

This has several advantages, including:
the ability to buy more than one item when shopping online, particularly to make shipping charges “worth it” i.e. when considering the cost of shipping items individually compared to possibly combining multiple orders into a smaller number of shipments or only one shipment
the opportunity for a user to fully consider their purchases in a shopping basket before initiating a purchase at checkout
allowing users to build and save a basket so that they can check-out at a later session
a shopping basket which is more consistent with other e-commerce experiences
increasing the average order value and average number of items per order
In a typical embodiment, certain simplifications may be adopted, for example:
The user is limited to applying one payment method for the entire order.
The entire order must be shipped to a single destination.

Other embodiments may not be so limited.

Typical embodiments may also present one or more of the following features:
Shopping Bag Indicator
   Indicates the current number of items in the basket
   Displays a preview of basket items that displays:
   Product thumbnail
   Designer name
   Product description
   Price
   Size
   Gives a visual indication when an item has been added to the basket
Product Page
Shows a “Checkout” button after the item has been added to the basket
Shopping Bag page
Displays the contents of the shopping bag, and optionally
   Groups items by retailer and their relative estimated shipping
   Allows user to remove items
   Allows user to increase or decrease quantities
   Moves an item to their List
   Is persistent across devices for signed in members
   Displays a total for the basket items
Payment page
   Displays shipping options grouped by retailer
   Detects and displays the common payment methods accepted by all the retailers related to the order
Order Review page
   Groups items by retailer and their relative shipping cost
   Displays the selected shipping method for each retailer (with a way to change it)
   Displays the estimated shipping time for each retailer
   Displays an overall total for the order
Order Placement
   Exhibits a graceful fail if one or more transactions of a multiple-item, potentially multiple retailer, order fails i.e. allowing for partially successful orders, with some orders allowed to proceed to completion, whereas some retailers are unable to comply
Confirmation email
(sent by the system sends upon order submission)
   Displays orders from multiple retailers in a single confirmation email
   May also inform of partially successful orders
Order History page
(accessed from the user settings)
   Groups items by retailer
   Displays the selected shipping method for each retailer
   Displays an overall total for the order
Abandoned basket email program
   Reminds visitors of items that they left in their basket but have not purchased.
   This email program has triggering rules and tracking properties to measure effectiveness.
   Optionally, combined with promotional incentives, for example via the support of promotional codes in the checkout process.
Post-Purchase satisfaction survey
   Adapted to handle orders placed with multiple retailers.

### Non-Member and Member Checkout

FIG. 11 show flow diagrams of a transaction in the case where the user placing the order for the transaction is a new customer and where the user is a returning customer (hence the user is a registered member in the merchant system server).

FIG. 11a shows the process where a new customer (preferably, herein referred to as a “guest”) submits a transaction order at the checkout of the merchant system. Given that the user is a new customer, the user is not a registered member in the merchant system server. Once the user has been identified, at an authentication stage, as a new user, pertinent details such as shipping address and payment information is completed. The user's order is subsequently reviewed at a review order page and the order is subsequently submitted (or amended and then submitted) by the user.

The merchant system server analyses the contents of the user's basket to determine the merchants that correspond with the items the user wishes to purchase. On an item-by-item basis, the merchant system server queries whether the merchant for a given item supports transaction orders to be submitted at checkout by a guest. If the merchant for a given item supports guest transaction orders to be submitted, then the order is submitted to the merchant for the given item and a confirmation, such as an order submit page generated for the given item.

If the merchant for the given item does not support guest transactions and instead requires a customer account to have been registered with the merchant, then the user is asked either to sign-in to a pre-existing account with the merchant server or have the merchant system server automatically generate an account with the merchant (given that the merchant system server holds pertinent information about the user, such as their email address).

If the user opts to sign into their pre-existing account with the merchant, then a query is generated by the merchant system server securely requesting the account details (such as the user's email and password) for their pre-existing account; this is subsequently submitted to the corresponding merchant server and authenticated. If the user is successful in signing-in to their account, the order is submitted by the merchant system server to the corresponding merchant and an order confirmation generated. Conversely, if the account details are incorrect an error message is submitted and the user is asked to re-input their account details, or alternatively to have a new account created automatically by the merchant system server.

If the user opts for a new account to be created, the merchant system server queries whether, based on the user details held by the merchant system server, an account is already registered (which the user may have forgotten about) with the merchant, if not, then the order is submitted based on an account generated automatically by the merchant system server (based on, for example, the user's email stored by the merchant system server and an automatically-generated password). If an account is already registered with the merchant then an error is generated and the user invited to sign-in to their account with the merchant.

It is appreciated that a user basket may contain a number of items, from a number of merchants, which may or may not support guest transactions and/or a user may or may not have pre-existing accounts with some of the merchants. It is therefore likely to be the case that multiple, if not all, paths of the process will be run simultaneously. The merchant system server therefore allows the user to be connected to multiple websites, be it as a member or guest, while only interfacing with the merchant system server. This allows for a much more efficient and faster checkout experience for the user.

In order to facilitate the automatic generation of user accounts with merchants, the merchant system server utilises wireframes.

During a user's shopping experience, users are notified that items in their basket would require an account for a transaction order to be submitted with an option to use a pre-existing account or create a new account (as further described with reference to FIGS. 11c-11e). For a user that is registered with the merchant system server, pre-existing merchant accounts for that user, are linked with their user account on the merchant system server. Otherwise a merchant account is available to be created while the user is still shopping.

FIG. 11b shows various user interfaces of the merchant system, notifying users that an account with a specific merchant is required and a dialogue for input, generated by the merchant system server, of a user's account details with a specific merchant.

FIG. 11c is a process flow diagram showing the method by which items being added to a user's basket are handled by the merchant system where the user is a guest. Once a user has submitted an item to their basket, the merchant system queries whether an account is required with the merchant system and/or merchant of the item added to the basket (also referred to as the “bag”). If an account is required, then the item is added to the basket along with a notice to the user that an account is required (e.g. “Account required”) in order to submit a transaction order for the item that has been added to the basket. If no account is required, then the item is added to the basket and displayed without the notice.

At the checkout, the user is presented with the following choices:
1. To submit an order for the items in the basket for which no merchant account is required
2. To submit an order for the items for which the user has a pre-existing connected account, which would require the user to sign-in to the merchant system server or (merchant) external server (via the merchant system server, in which case the process described with reference to FIG. 11d is used)
3. To create a new account with the merchant in order to be able to submit a transaction order for all items in the basket.

Once any of the above options have been selected by the user, an order is submitted.

FIG. 11d shows the process of FIG. 11c, but where the user is not a guest and instead is a registered member of the merchant system that has successfully signed-in.

FIG. 11e shows an exemplary user interface of the kind returned to the user when items added to the user's basket comprises items for which an account is and is not required.

### Further Aspects

Some further aspects of the system are now discussed in additional detail.

### Velocity Control

This process is used to perform a real-time stock check for an item to ensure a user purchase proceeds smoothly. The placing by a user of an item into the user shopping basket may be considered as an “intent to buy”. The merchant system queries the retailer for stock availability once at that stage (even if two or more users have added the item to their baskets, only one stock level check is required), and again at the time user confirms they wish to proceed with the purchase. The rate of stock level checking may depend on stock level; eg. made more frequent for popular items.

Further last-minute checks may be performed on other key attributes such as size, colour and price—a price inconsistency (outside, say, a predetermined threshold) may trigger halt of a purchase (or that part of a multi-purchase), and/or flag a user notification.

### Autoclassifier

FIG. 11 shows an overview of the ‘autoclassifier’ classification process.

All links retrieved by spiders from retailer websites go through a process of link moderation in order to allow for the item linked to be classified appropriately. This process involves checking key fields of each link for accuracy and editing these appropriately, if required. Typical fields include:
type (e.g. apparel and shoes)
category (e.g. mini dress and high heeled shoes)
colour

Additional fields may include one or more of:
size
gender
designer
description
classification/category and sub-category
name
product code (used by some retailers for classification purposes)
colour

In particular, it is important to classify items according to a uniform taxonomy, ensuring that different items are grouped together although potentially being labelled with different terms, and contrarily, that items labelled by identical terms are nevertheless differentiated if they are in actuality significantly different.

In some embodiments, link moderation is performed by human moderators, say editing item labels according to a standard naming scheme. However, this scales poorly, and with a plurality of merchants each offering a range of items (each in many colours, sizes etc) the moderation backlog can become very large (potentially hundreds of thousands of links or more). There are also issues of consistency, with variations between individuals in aspects such as colour and particularly in subjective assessments, such as style.

Where a policy is adopted of not allowing a link to appear on the system unless it is moderated (unmoderated links potentially detracting from the user experience), the backlog may mean that items or products may go out-of-stock before they even appear on the system.

The aim of the autoclassifier is to facilitate rapid classification by estimating the moderated fields with a high probability of accuracy, reducing the backlog of unmoderated links and thereby ensuring new products appear on the system quickly.

### Colour

FIG. 18a illustrates a process for detecting and consistently categorising colours (preferably, herein used to refer to patterns of several different colours also) associated with items as part of a description of an item.

Colours are generally provided, across external data sources (such as merchants), inconsistently and as semi-structured data. Colour is therefore one of the most difficult fields to normalise. Even simple colours such as ‘snakeskin’ or ‘periwinkle’ can be hard to process automatically.

A range of techniques to map merchant colours to colour names used in the merchant system server 10 are used including simple keyword matching to complex machine learning models. However, these methods produce somewhat unsatisfactory results due to complexity of colour names used by external data sources. Product colour is therefore determined via external data source item images as described with reference to FIG. 18a.

Having extracted from an external server (e.g. servers 20, 22, 24 and 26) an item image and removed the background colour of the image (as described with reference to FIG. 17), the colours of the item in the image are identified by first applying a colour clustering function that relies on a N×3 (where N is a number greater than 1) matrix where each row of the matrix represents an RGB (Red-Green-Blue) pixel. The main colours of the extracted image are deemed to be the cluster centres. An algorithm that dynamically determines the number of clusters is used (as opposed to fixed cluster sizes), for example by means of see mean-shift or DBSCAN functions of Python, because a fixed number of clusters tends to result in “muddy” colours. The number of clusters and/or number of pixels (e.g. the value of N) may vary on a number of factors including: resolution, homogeneity of colour, type of image, etc. and may vary within an image.

FIG. 18b demonstrates the resulting processing of an image using colour clustering. The first image 1800-1 shows detected colours from an image of an item (wherein the item is the t-shirt) ordered by the percentage of pixels in a respective colour cluster. The second image 1800-2 shows the cluster-space pallet wherein shadows are clustered with green (e.g. around the chin and neck area of the model) whilst highlights have been clustered with pink (for example around the text on the t-shirt).

Having accurately extracted colours (as shown as hex codes in the first image 1800-1 of FIG. 18b) for the item image the next step is to translate these hex values into colour names.

The colour names used by the merchant system server 10 to describe products are loaded; these names are stored on an internal database in the merchant system server so that users can filter items by these colour names.

Mapping from a hex value (as identified in the colour clustering process) to a colour is subsequently performed. In order to do so, survey data which designates colour names to regions of colour on a plot of hex colour codes is used; in one example this consists of approximately 200,000 RGB values categorised by name from a small set of colour names. This set may be modified by including additional colour names such as ‘beige’ and ‘grey’ and a hardcoded threshold for white and black, as it is difficult to have perfectly white and black clothes in item images. Having loaded the colour survey, which despite having at least 200,000 hex code entries, is not complete over the RGB space (which comprises 255³ colours, and 200,000 therefore represents only approximately 1.2% of all colours). In order to map all hex colours to names the distances between hex colour codes is therefore considered.

A metric of colour difference is defined using a colour space in which to measure distance between hex codes. An RGB-based colour space is not suited to measuring colour difference because distance magnitudes in an RGB colour space do not necessarily correspond to the magnitude of colour difference as perceived by humans. For example, to rectify this deficiency the International Commission on Illumination (CIE) defined the tab colour space which aims to attain so-called perceptual uniformity. CIE has defined a number of colour difference functions, including CIE1976 and CIE2000.

With a measure of colour distance between the points on the colour survey and the hex colour codes identified in the colour cluster process, a determination is made as to what the closest colour point on the colour survey to the hex colour codes identified in the colour cluster process.

For processing efficiency, colour distance calculations are performed using vectorised colour distance functions, such as “deltaE” (a function for identifying colour distance in the colormath module in Python). When used with large data-sets the vectorised implementation, which relies on the magnitude of such vectors to determine quantifiable colour difference, is approximately 25 to 180 times faster than otherwise. An exemplary portion of the deltaE code (including an output of the nearest colour found) used in the process function is shown below:
import csv
import numpy as np
from colormath.color_objects import Lab Color
# load list of 1000 random colors from, the XKCD color chart
reader=csv.DictReader(‘lab_matrix.csv)
lab_matrix=np.array([map(float, row.values( )) for row in reader])
# the reference color
color=LabColor(lab_l=69.34,lab_a=−0.88,lab_b=−52.57)
# find the closest match to ‘color’ in ‘iab_matrix’
delta=color.delta_e_matrix(lab_matrix)
nearest_color=lab_matrix[np.argmin(delta)]
print ‘% s is closest to % s’ % (color, nearest_color)

Once the nearest colour point on the colour survey is identified, the colour name to which this point belongs is attributed to the hex code identified during the colour cluster process and this merchant system colour term applied to the item.

FIG. 18c shows the result of a number of exemplary colour matching processes from the external server colour names and images to merchant system colour terms.

Feed Architecture

The autoclassifier is built on top of a feed architecture—a feed being a structured document detailing all products available from a retailer. Using feeds is advantageous because they enable separation of content from presentation. The presentation layer (i.e. the website) is often of limited use from a data acquisition perspective, sometimes proving to be an obstacle to the collection of the underlying item data.

The feed architecture has a configuration for each retailer which describes where their feed is located and how their feed should be parsed. The feed architecture transforms all these heterogeneous external feeds into a consistent homogeneous internal format.

The spiders then make use of the feeds using a ‘mixin’ (a plugin). The feeds are in a consistent format so a single plugin can be used for all spiders. This reduces code, maintainability costs and increases reliability. It also means that use can be made of feeds outside of the spiders, for example the feed architecture may be used to manage the stock status of products (i.e. whether a product has gone out of stock or come back into stock). This first requires feeds to be transformed into a consistent format.

Autoclassifier Process

The autoclassifier process makes use of a Support Vector Machine (SVM) model. SVMs are a form of supervised machine learning that are first trained on example data and then used to make predictions on real-world data. They function by mapping the data into a high-dimensional feature-space and estimating a separating hyperplane in that space such that the distance between relevant observations (i.e. the support vectors) and the hyperplane is maximised.

Predictive models (SVM classifiers) are trained via the feed on five fields (gender, color, type, category and subcategory).

The models then use textual descriptions of the product (provided by the retailer in the feed) to predict the fields which are not in the feed. Previously these fields would have been provided by the human moderators.

Simply predicting all fields is inadvisable because there is some level of uncertainty associated with each prediction. Instead, for each prediction a probability of correctness is generated based on the observations distance from the separating hyperplane in the n-dimensional feature space.

More details on the probability calculation are described in Drish ‘Obtaining Calibrated Probability Estimates from Support Vector Machines’ (available at http://cseweb.ucsd.edu/users/elkan/254spring01/jdrishrep.pdf), which is hereby incorporated by reference.

With the set of probabilities which correspond to each prediction a probability-threshold p is estimated whereby any prediction with a probability greater than the threshold is deemed to be correct. If the predicted probability is below the threshold then the item is sent to the human moderators instead of being placed directly on the system.

The probability-threshold is estimated using a bounded minimisation algorithm (also known as a Broyden-Fletcher-Goldfarb-Shanno or BFGS method) where the cost function is the accuracy of the SVM predictions at a given probability-threshold.

In some embodiments, an SVM solver may be used speed up training and prediction, potentially by several orders of magnitude. An example of such a solver is described in Shalev-Shwartz, Singer & Srebo ‘Pegasos: Primal Estimated sub-GrAdient SOlver for SVM’ (available at

http://eprints.pascal-network.org/archive/00004062/01/ShalevSiSr07.pdf), which is hereby incorporated by reference.

The spiders use the autoclassifier via a mixin (a plugin in the same way as the feed architecture). This is possible thanks to the feed architecture which provides consistency across all retailers. The trained classifiers are stored in the cloud and retrieved by the spiders as needed. Preferably, classifiers are cached by the spiders and only updated when a new classifier is placed in the cloud.

In some embodiments, classification may also include converting colours into standard colours, performing hashing on item images (for example, to determine the item shape) and/or analysing aspects of the description, potentially as a cross-check of the retailer classification.

### Recommendation Engine

FIG. 12 shows on overview of the recommendation process, as performed by the recommendation engine. This makes use of item attributes and metadata to generate information on products the user may like and provide recommendations.

The results of the recommendation engine may be used to set out the initial display or “virtual store” of items offered from the various retailers by the merchant system and to refine the display as the user interacts with the merchant system.

In a highly subjective and fast-moving retail environment such as fashion, a ‘good’ recommendation necessarily requires more sophistication than indicating what other users viewing or purchasing a particular item have also viewed or purchased. A ‘good’ recommendation may enhance the entire shopping experience for a customer.

Many different and interrelated factors may be relevant for making a ‘good’ recommendation.

This is addressed by a recommendation engine comprising a plurality of recommendation sub-engines. This allows for a modular and flexible system of generating recommendations, with the outputs of certain recommendation sub-engines being used as the inputs into others.

These individual recommendation sub-engines may be considered to form a hierarchy.

The sub-engines with system-weightings effectively act as filters e.g. determining items new in the last three months. Some may make use of a user-defined parameter eg. budget.

These results are then fed into the user-weighted sub-engines to produce a recommendation. The user-weighted sub-engines take account of user interaction with the merchant system, for example, what items are being considered, which are being scrolled past without further consideration.

Essentially, items are allocated an initial recommendation weighting, determined from whatever initial information may be ascertained about the user, if any. As further user data is gathered, these weightings are adjusted.

Examples of recommendation sub-engines include:
Retailer recommendations
Budget recommendations—based on a projected budget/average order value of the user/spread of budget across different types of items e.g. expensive main item with cheaper accessories, typical budgets for particular retailers, characteristics (eg. colour) of items viewed or purchased
Seasonal recommendations
Follower recommendations—based on declared interests of the user e.g. a particular designer or magazine
Influencer recommendations—based on newsworthy items
Recommendations based on user likes and/or dislikes

To further enhance the user experience, feedback is given with the recommendations to explain why the particular recommendation was made.

In more detail, the recommendation engine system comprises two stages:
Ranking—which comprises selecting products that a given user is likely to find attractive
Merchandising—which comprises combining or grouping products into a set that is both pleasing to the user as a whole (for example, according to parameters determined to be of importance to the user and/or aesthetically) and meets certain merchandising requirements.

Ranking Stage

When retrieving top recommendations for a user, from several sources, the ranking component generates a general predicted-preference ordering for a given user over all products. It does so through a combination of several sub-scores, for example:
Personalized preference ranking

This attempts to predict which products a user will like, given the user's past actions on the system. This is accomplished through a hybrid recommendation algorithm, combining features of content-based and collaborative filtering recommendation systems
Overall product popularity

This reflects the site-wide popularity of a given item. Products that more users interact with are considered more popular.
Product freshness

This reflects two features of a product: how recently it has been added to the site, and how recently it was added to a product or item list on the site by one of the user's followed users. This captures both novelty/seasonality and social components.

When an overall ranking is desired, each of these components is assigned an importance weight, and the weighted scores are combined to produce a final preference ranking. The top ranked items are then used as candidates for the merchandising component.

The weights are determined on a user-by-user basis, using a pairwise ranking algorithm, giving higher weights to the characteristics determined to be more important to a given user.

The key output of the recommendation algorithm is the user model, which describes a user's preferences over products in the form of a coefficient vector. This vector expresses the user's liking for i) basic product features (such as colour or category) expressed in that product's metadata; and ii) product latent features, computed using collaborative filtering techniques.

User and product models are computed using a modified version of the Weighted Alternating Least Squares (WALS) algorithm, described in Hu, Koren, and Volinksy ‘Collaborative Filtering for Implicit Feedback Datasets’ (2008), which is hereby incorporated by reference.

In the original algorithm, the input data of the algorithm consists of a user-product matrix: a binary (0/1) matrix in which rows represented users, and column represented products; positive entries in the matrix represented interactions between a given user and product, while zero entries denoted the lack of any interaction. For example, if user 10 has interacted with (eg. selected) product 30, then the (10, 30) entry in the matrix is set equal to one (and zero otherwise).

The goal of the algorithm is to represent this matrix as a product of two smaller matrices, which represents so-called latent user and product factors. While the factors themselves may not have a straightforward interpretation, when combined together they will approximate the original user-product matrix, and predict other products that a given user will like.

Because WALS deals only with user-product interactions, and not with user or product metadata, it has no concept of product characteristics, and is unable to estimate a user's preference for particular categories of products (for example, jeans or t-shirts), colours, or price. Combined with the fact that WALS performs best where a large number of users choose from a relatively small catalogue of data, its use is challenging in the following situations:
where the number of products is large relative to the number of users;
where the recency of a product is important (items newly added to the catalogue are more attractive); and
where the catalogue items have rich metadata.

To surmount these difficulties, a modified version of the WALS algorithm is used, which performs joint estimation of user latent factors and content coefficients, i.e. user preferences for price, category, subcategory, and colour are computed at the same time as their preferences for latent factors.

The basic WALS algorithm proceeds according to the following steps:
1) The product latent factor matrix is initialized using small random values.
2) The user latent factor matrix is then estimated by regressing entries of the user-product matrix (via weighted ridge regression).
3) The product latent factor matrix is estimated by regressing entries of the user-product matrix on the user latent factor matrix estimated in the previous step.

The modified algorithm proceeds according to the following steps:
4) The product latent factor matrix is initialized in two steps:
i. The latent product factors are initialized using small random values.
ii. The content-based part of the product matrix is initialized using a matrix encoding of product metadata.
5) The user matrix is computed as before, but now consists of two components: latent factors corresponding to product latent factors, and content coefficients corresponding to the encoded product metadata.
6) Only the latent factors of the product matrix are recomputed, via regressing the difference of the user-product matrix and the product of the content part of the user and product matrices on user latent factors.

The result combines the advantages of content-based and collaborative filtering recommender systems, and allows prediction of user preference for new items as soon as they are added to the catalogue.

When combined, user and product models yield personalized ranking scores, for all users over all products. A higher score indicates a higher expected preference for a given item.

Item Recommendation System

Data is collected on the basis on users' behaviour interacting with the merchant system server 10, in particular each item view, mouse hover, click and/or entry into a basket constitutes items for which users have interacted (referred to as “positive items”), whereas for items with no views, mouse hover, click and/or entry into a basket there has been no user interaction (these items are referred to as “negative items”). As part of the data collected by the merchant system, trends in user activity are also recorded.

From a set of items a user has viewed during a given session interacting with the merchant server system a set of implicit preference relations is extracted. In one example this comprises assuming that every product the user has interacted with in a given session is preferred to every product the user has seen but not interacted with in that session, a list of positive-negative item preference pairs is subsequently compiled as examples of a user's preference relations.

The preference pairs are fed to a machine learning algorithm, which processes the features of both items of a pair to “learn” the direction of the preference relation given a feature (where features include, for example, designer, retailer, category, subcategory, colour, and a large number of textual fields derived from product descriptions). For example, if most of the positive items for a given user (but few or none of the negative items) are blue jeans, then the algorithm will learn that, in general, blue jeans are preferred to things that are not blue jeans.

The process is based on a linear classifier, for example a Support Vector Machine (SVM), though it will be appreciated that, in principle, a much larger class of algorithms may be applied to this problem.

The commonalities between models derived from different users' interactions are extracted in order to train a model that is a function of a plurality of users' behaviour in order to enrich the models. For example, the merchant system server may be have information detailing that user A likes blue jeans, but not user A's preference for blue shirts. Knowing that other users (e.g. users B, C, D . . . etc.) who like blue jeans also, like blue shirts allows the merchant server system to assume that user A will also like blue shirts; this is accomplished by computing a reduced dimensionality representation of all user models through a process known as Sparse Dictionary Learning. All individual user models are represented as linear combinations of a fixed number of dictionary atoms (archetypes or typical users), and then re-projected onto the original space.

In this manner the recommendation engine performs collaborative filtering, that is filtering on the basis of multiple sets of data, each reflecting a user's behaviour when interacting with the merchant system server.

At the point that the recommendations engine publishes recommendations to users the trained model is used to predict the direction of the user's preference relation on new (unknown, in the sense that transform pairs have not yet been determined) pairs of items. Each item in the merchant system server database is assigned a score for denoting confidence that the user will like the new product; this is then combined (in one example, in a weighted additive fashion) with other pertinent product features (such as the new product's overall popularity or ‘freshness’) to produce a final score. The final score is then used to sort and present the recommendation results to the user.

Merchandising Stage

The merchandising stage takes the outputs of the ranking. It performs one or more of the following functions:
Ensures sets of recommended products complement each other, using data on what products are bought together, and what product categories form consistent sets
For ICON cart recommendations, it ensures recommended products fit within the user's estimated budget, based on the user's demographics and past purchase history

Generally, recommendations may be made at various stages of the user interaction with the merchant system, including initially at item browsing and at the checkout stage.

### Proactor

The purpose of the proactor is to ensure high quality data, reject bad data, and to shield the database from having to update every item which gets scraped. In general, it provides a protection and control layer in front of the database, effectively detecting problems before they occur, which can scale together with the scraping capacity.

The design of the proactor allows different layers of integrity and scalability checks to be performed before updating an item on the database. These layers may be considered to form a pipeline; every item has to pass all stages in the pipeline.

Example layers include:
price protection—which ensures high quality data
item diffing—which improves scalability

These layers may be implemented in various technology stacks, for example:
redis—an in memory database (an open source key-value store or data structure server, available at http://redis.io/)
scipy—an open source library for efficient scientific computing (available at www.scipy.org)
numpy—an open source library for numerical computing (an extension to the Python programming language, available at www.numpy.org)

Price Protection

The Price Protection layer aims to detect ‘bad’ (e.g. too low, too high etc) prices before a product is updated in the database. A bad price eventually leads to a failed ICON checkout because the retailer price cannot be matched with the current price on the system for the given product. This may not only result in a poor user experience, but also lead to a lost sale.

Detecting a ‘bad’ price may be done by maintaining a price history and monitoring for outliers (prices would generally be expected to remain steady over the timescale of days). However, for systems scraping the details of potentially millions of items a day, it may be unfeasible to maintain such a price history for every item.

The price protection layer therefore builds a price distribution per retailer (and per currency and product type, such as ‘apparel’), typically over a number of days, and rejects any price which has a very low probability of appearing given this distribution (typically about 0.1%).

The problem of detecting ‘bad’ prices becomes one of calculating the parameters of a lognormal distribution (as prices are usually following that distribution) in an iterative way. The parameters for the retailer are updated as new pricing information arrives, with the ‘estimate’ parameters eventually converging to the ‘true’ parameters of the distribution, eventually allowing the price probability density function for a given retailer to be calculated.

A suitable formula for this purpose is one based on a running variance computation described in Knuth ‘Art of Computer Programming’ (3rd ed) Vol 2, p 232 (and also available at http://www.johndcook.com/standard_deviation.html), which is hereby incorporated by reference—modified as described above for lognormal distributions.

Item Diffing

To have timely data (price, stock status) in the system ideally requires scraping retailer websites and product pages as frequently as possible. For the most high profile retailers, potentially being visited multiple times a day, this may lead to many products being scraped for which the data has not changed during the day It would be inefficient to send this unchanged data directly to the database each time.

‘Item diffing’ is therefore used to detect if a link has changed (i.e. if the price or stock status differs from what is currently stored in the system database) without interacting directly with the database.

Information on every link is maintained in a set (outside of the database) and every incoming link is checked against the set membership. In order to determine whether data for a particular item has changed only requires knowledge of whether the item is a member of the set or not, not on any other details of the item. This evaluation may be performed by applying a very time- and memory-efficient data structure called a bloom filter.

A bloom filter is a probabilistic data structure which allows a determination to be made as to whether an item is possibly a member of a set, or definitely not a member of the set. False positives (considered as in the set when actually not in the set) are possible while false negatives (considered outside the set when actually in the set) are not. This allows for detection with certainty when item data has changed, while allowing the false positive rate to be kept under control by the parameters chosen in setting up the bloom filter.

### De-Duplication

Where large volumes of items are handled across various external data sources, duplication of items may occur, which is undesirable as it results in a larger database and a poorer experience for the end user. A “de-duplication” method is used to identify duplicated items. Identifying duplicated items on the basis of identical images or textual descriptions may be used and in certain circumstances is a somewhat trivial process. However, items listed in the merchant system server database may still be duplicates, but comprise material differences in the data fields associated with the item, including the textual descriptions and surface representations of the item indicated in their associated images (referred to as “lexical” differences).

De-duplication is performed by first calculating a set of image descriptors, such as those based on Binary Robust Invariant Scalable Keypoints (BRISK) or similarly SIFT, SURF and FREAK methods, on each item image. The BRISK descriptors are subsequently clustered into a reduced-dimensional histogram such that the histogram comprises bins along a i axis, such that the histogram represents the multiplicity of descriptor i in the reduced descriptor space. The histogram of the potential duplicated image is then compared to histograms corresponding to images previously stored in the database to determine similarity. The extent of similarity may be determined by a statistical measure, for example ‘Chi-squared’ distance; the smaller the distance, the more similar the images. Advantageously, the algorithm used for de-duplication is invariant to scale and rotation transforms.

Simultaneously, textual analysis of item features is used to filter the histogram distance matches, nonetheless even if items have the same taxonomy discrimination is possible.

De-duplication between two slightly different items, with respect to the item images (or differing patterns) and/or textual descriptions. In this manner different records of, for example, a merchant and a fashion supplier listing an item, but using different descriptions and/or images are available to be recognised as a single item and merged. A network between multiple merchants and suppliers is therefore created in order to produce a central database of items without duplicates.

FIG. 16 shows a schematic of the architecture of the de-duplication system employed by the merchant system as part of the integrated checkout process to optimise the merchant system database by identifying and removing duplicate item entries.

An input retrieves historical image data previously stored on the merchant system's database (pre-optimisation) and new item images retrieved from merchants which are to undergo the de-duplication process. The input feeds both historical and new image resources to a stream processing unit (for example, as provided by Apache Storm). The input module relies upon a queuing system (for example, as provided by Apache Kafka) to place candidate duplicates in a queue. The stream processing unit retrieves the candidate duplicates from the input for processing.

The stream processing unit allows for distributed computation of streams of data (for example, as provided by Apache Hadoop). A stream of candidate duplicates retrieved by the stream processing unit takes the form of a series of item images. Using an image descriptor analysis method, such as BRISK, keypoint descriptors for each image in the stream are calculated. The keypoints descriptors are put into a k-means model (a clustering model, for example as used to transform BRISK keypoint descriptors into lower-dimensional histograms) to produce a histogram at a k-means sub-module of the stream processing unit. The k-means sub-module is, for example, a layer sitting on-top of the stream processing unit that allows transactional processing (once-only semantics) to be performed (for example, as is provided by Apache Trident) as defined by a high-level domain-specific language on top of the stream processing unit (for example as provided by the cascade function in Apache Hadoop). It is therefore possible for K-means models to be trained in a streaming manner.

Once the stream is processed by the k-means sub module, a Elastic Search (ES) is conducted by an ES module to identify duplicates from the candidate duplicates. The histograms, stored in or accessible by the ES module, are used to find images that similar to one-another. A Chi squared statistical test is performed in order to determine the likelihood, based on the forms of image histograms, of duplication of image entries in the database and therefore return a more memory-efficient database.

A scalable key-value store (for example, as provided by DynamoDB (DDB) by Amazon™ or by memcache systems. Stores mappings from image histograms. The ES draws histograms from the scalable key-value store in order to carry out a search.

### Background Removal

In order to allow uniform presentation and allow consistent image analysis (such as identifying the main colours) of item images from various merchants, the backgrounds of these item images (which are typically superfluous to the item) are removed or reduced. Backgrounds may comprise simple arrangements of colours, colour gradients or complex backdrops, such as scenes or landscapes (e.g. a beach, street, etc.). In order to infer correctly properties about an image of an item the background is removed or reduced. Furthermore, the image manipulation is performed in a time-efficient manner in order to process large volumes of items per unit time.

FIG. 23 shows a process by which image backgrounds are removed or reduced, an item image (of a boot) corresponding to each step of the process is shown alongside each step.

In a first step, an item image (the original image) is extracted from an external data server; this image is subsequently duplicated to form a layer that is to act as a mask. The duplicated image is inverted to produce a negative (in order to produce clear boundary lines when an edge detection process is applied, and avoid double lines for detected edges). An edge detection process, for example by using a Sobel operator, is applied to the negative, the edges are smoothed by means of a blurring operation, for example using (multiple iterations of) a Gaussian blurring function in order to remove outliers that remain from the edge detection process.

A thresholding process is then used to segment the smoothed image, for example such that non-black pixels are converted to white pixels. The thresholding process is subsequently repeated on a localised array of pixels, for example an area encapsulation at least nine (a three-by-three pixel area) or twenty-five pixels (a five-by-five pixel area) such that pixels that are not part of clusters of white pixels are filtered out. The resulting image is subsequently filled with a uniform colour (such as magenta, blue or green) using a flood fill process applied from the corners of the image to allow chrome key-type processing. The flood-filled area is turned transparent in order to act as a mask on the original image. The mask is then applied to the original image and the background therefore masked leaving only the item visible.

The above-mentioned image processing is executed on a processor, preferably a graphical processing unit, on the merchant system server.

By making assumptions on item image data based on item rules, complex model-based background removal is avoided (thus providing a more efficient system) and instead use filter-based techniques. During processing it is assumed that the “main image” of a product is substantially facing forward and centred in the image. The advantage of this technique is that the background of an image may be removed within approximately 15 ms-45 ms and preferably 25 ms-35 ms.

These are a combination of chained support vector machines and stochastic gradient descent based classifiers. Items which we are not confident enough to classify are passed to human moderators.

As part of the various classification processes described, we have a number of classifiers which run on images. For example, a classifier which determine the main colour(s) of an image. In order to approach the problem of colour identification, image manipulation methods rather than complex image recognition techniques are used for speed and efficiency.

Techniques used include global adaptive thresholding, which is used to find a colour value which is between the background colour and the foreground colour of the item image. Any pixel that is within this threshold is used to create an alpha mask. For images with gradients, complex backgrounds or items which are lightly coloured further processing is employed in order to determine where the item lies within an image. As image manipulation methods are used the following assumptions are held to be true for each item image:
1. The product will be in the image
2. The product will be prominent in the image

In terms of pixels, this means that the transition from background to item will be strong and as such the edges of the item in the image detectable. Several methods for performing edge detection exist, such as the graphicsmagick edge( ) function (which is a Sobel Filter (based on the graphicsmagick source) from pg-magick). Local adaptive thresholding as well as the Sobel filter is used, however in some cases this may add larger borders to the transparency masks. An exemplary portion of code used to during this process is shown below:

```
import pgmagick as pg
def trans_mask_sobel(img):
  “““ Generate a transparency mask for a given image ”””
  image = pg.Image(img)
  # Find object
  image.negate( )
  image.edge( )
  image.blur(1)
  image.threshold(24)
  image.adaptiveThreshold(5, 5, 5)
  # Fill background
  image.fillColor(‘magenta’)
  w, h = image.size( ).width( ), image.size( ).height( )
  image.floodFillColor(‘0x0’, ‘magenta’)
  image.floodFillColor(‘0x0+%s+0’ % (w−1), ‘magenta’)
  image.floodFillColor(‘0x0+0+%s’ % (h−1), ‘magenta’)
  image.floodFillColor(‘0x0+%s+%s’ % (w−1, h−1), ‘magenta’)
  image.transparent(‘magenta’)
  return image
def alpha_composite(image, mask):
  “““ Composite two images together by overriding one opacity
  channel ”””
  compos = pg.Image(mask)
  compos.composite(
  image,
  image.size( ),
  pg.CompositeOperator.CopyOpacityCompositeOp
  )
  return compos
def remove_background(filename):
  “““ Remove the background of the image in ‘filename’ ”””
  img = pg.Image(filename)
  transmask = trans_mask_sobel(img)
  img = alphacomposite(transmask, img)
  img.trim( )
  img.write(‘out.png’)
```

In the cases where background reduction has removed portions of the background element and item element, then colour classification, as described with reference to FIG. 18 can still be used.

### Main Image Detection

A challenge in classification of items from various merchants is in determining which image in a set of images of an item is the “main image”, that is the image that most effectively represents to a user the item (or is intrinsically most indicative of the item). The “main image” is selected on the basis of item rules (which may differ from the rules employed by the source merchants), e.g. a shoe must have no model in it and must be facing 45 degrees from a forward position in the photo.

For each item subcategory (e.g. high heels, long sleeved tops) a sample of (potentially human) moderator approved “main images” are compiled—numbering at least 1000, 2000 or 5000 images. The background of each “main image” compiled in each subcategory has its background removed, with the additional step of forming an outline of the shape of the item in each “main image”. The outlines are then used to train a statistical model such as a random forest spatial model, in order to produce a generic guide as to what the outline for a main image of a particular sub-category of item should look like, for example for a high heel shoe; this is then used in a similar manner to the autoclassifier process described above with reference to FIG. 16, typically returning results with 99% accuracy 60% of the time.

Category and/or Sub-Category Identification

Using the method of identifying the “main image” for a given item the category and/or sub-category of an item may also be identified, wherein much less information may be relied upon than the same process used for “main image” identification (i.e. where the category and/or sub-category is known, thereby informing which model or generic guide is to be used). Category and/or sub-category identification is most advantageously used where external data sources (for example merchants) have provided poor textual descriptions that do not restrict the extent to which categorisation may be undertaken (for example, description such as “100% cotton” are used, but used across multiple categories and sub-categories).

In such a scenario, rather than comparing the image set to large set of images known to be indicative of a particular item, this process is looped over a succession of different large sets of images corresponding to different items. In such a way, if a particular item returns a high degree of similarity (i.e. the outline of one of the images matches a model corresponding to a particular item) it can be assumed that that image is a) of that particular item (i.e. a shoe), and b) the most indicative of that particular item from the set of images.

After determining the main category of an item, the process may be repeated so as to refine further the category. For example, if the item is recognised as a shoe, the image (or set of images) may then be processed to see if it is most indicative of a high-heeled shoe, or of a boot. This iterative process speeds up the process as it reduces the number of statistical models that each set of images is compared.

### Counter-Fraud System

External servers (for example as used by merchants) often employ counter-fraud detection means in order to block activity which appears fraudulent. Typically, fraud detection (for example, on target service providers, websites or servers) only knows a location of a request from the server or computer from which the request was received (i.e. the last in the communication chain). If such a request comes from a user 30 that is based in a location A or the user's server that is based in a location A′ for instance, but is relayed via a server (such as the merchant system server 10) based in location B (where locations A/A′ and B are suitably far apart, perhaps even in different territories), then a fraud system will be alerted. Transaction order parameters (comprising shipping and billing details for example) are compared by fraud detection systems with the physical location of the server, computer or user from the last node in which the transaction order is sent. If there are differences (outside of allowed margins) the transaction order is usually rejected.

In order to avoid the merchant system server 10 from being blocked by these counter-fraud systems (as the merchant system server may be in a different territory to that of the originating request), data transactions for orders between the user, merchant system and external servers are undertaken via proxy servers.

The proxy server is the server through which traffic is pushed, as received from the merchant system server, to the external server. A proxy server arranged to match substantially the pertinent parameters (such as location) of the user's server means that traffic is interpreted by the external server (which is only concerned with information from the last node of the communication chain—the proxy server in this case) interprets a transaction order to have originated from a source (server, computer or user) that has the same (or substantially equivalent) transaction order parameters, for example such that the billing address of the user is substantially the same as the “physical location” of the proxy server thereby eliminating any disparity between the information provided by the user and merchant system server and making the request appear as if it had come from the user directly. The order is therefore approved by the merchant (using the external server) fraud detection system and the transaction completed.

### Modifications and Alternatives

In alternative embodiments, the merchant system may integrate directly into the retailer e-commerce system(s). This can however lead to added complexity, as almost every retailer has a different backend and expensive development time will be required to implement such a direct system. The merchant system described as the main embodiment is more “loosely coupled” hence much more accessible.

Alternative embodiments provide feedback from the merchant system to the retailers. Examples of such feedback include:
summaries and/or details of transactions relating to the specific retailer
trend information, relating generally to user purchases
user interest information, relating to user browsing and non-purchase information

It will be understood that the present invention has been described above purely by way of example, and modifications of detail can be made within the scope of the invention.

Each feature disclosed in the description, and (where appropriate) the claims and drawings may be provided independently or in any appropriate combination.

Any reference numerals appearing in the claims are by way of illustration only and shall have no limiting effect on the scope of the claims.

### SUMMARY

In summary, the present invention presents an improvement in electronic commerce, particularly in on-line shopping. Notably, the invention describes an easier way for users to interact with multiple merchant web sites by means of an intermediary, which not only aggregates product information from the multiple merchants but also simplifies the payment process by i) transcribing user transaction information into merchant-friendly formats and optionally ii) providing a multi-merchant shopping basket and checkout process.

1. A method of facilitating an on-line transaction, the method comprising:
determining a first format of transaction details as required by a merchant server for the processing of the transaction;
acquiring user information relating to the transaction from a user in a second format; and
transmitting the user information relating to the transaction to the merchant server in the first format.

2. A method according to claim 1, wherein the determination of the first format is via remote querying of the merchant server over a computer network.

3. A method according to claim 2, wherein the remote querying is by means of an agent or spider adapted to crawl a website associated with the merchant server.

4. A method according to any preceding claim, further comprising determining an item which is capable of being the subject of the transaction.

5. A method according to claim 4, further comprising aggregating a plurality of determinations for a plurality of items, preferably over a plurality of merchant servers.

6. A method according to any preceding claim, further comprising selecting an item for presentation to a user as an item which is capable of being the subject of a transaction.

7. A method according to any preceding claim, further comprising completing a transaction in respect of an item, preferably in respect of a plurality of items.

8. An apparatus for facilitating an on-line transaction, the apparatus comprising:
means for determining a first format of transaction details as required by a merchant server for the processing of the transaction;
means for acquiring user information relating to the transaction from a user in a second format; and
means for transmitting the user information relating to the transaction to the merchant server in the first format.

9. A method of facilitating an on-line transaction, comprising first and second transactions, the method comprising:
determining a first format of transaction details as required by a first merchant server for the processing of the first transaction;
determining a second format of transaction details as required by a second merchant server for the processing of the second transaction;
acquiring user information relating to the transaction from a user in a third format; and at least one of:
a) transmitting the user information relating to the first transaction to the first merchant server in the first format and the user information relating to the second transaction to the second merchant server in the second format; or
b) transmitting the user information relating to the first transaction to the first merchant server in a third format and the user information relating to the second transaction to the second merchant server in a fourth format.

10. A method according to claim 9, further comprising completing a transaction in respect of a plurality of items across a plurality of merchant servers.

11. An apparatus for facilitating an on-line transaction, comprising first and second transactions, the apparatus comprising:
means for determining a first format of transaction details as required by a first merchant server for the processing of the first transaction;
means for determining a second format of transaction details as required by a second merchant server for the processing of the second transaction;
means for acquiring user information relating to the transaction from a user in a third format; and
means for transmitting the user information relating to the first transaction to the first merchant server in the first format and the user information relating to the second transaction to the second merchant server in the second format.

12. A method of facilitating an on-line transaction, the method comprising:
monitoring the addition of items to a shopping basket; and
upon detecting the addition of an item to the shopping basket, checking a property of the item by querying a remote merchant server for information regarding the property.

13. A method according to claim 12, further comprising checking the property of the item upon detecting an indication that the transaction is to proceed.

14. A method according to claim 13, further comprising periodic checking of the property with a frequency dependent on the popularity of the item.

15. A method according to any of claims 12 to 14, wherein the property is one or more of: the stock level, size, colour and/or price of the item.

16. A method of classifying an item in dependence on item information obtained from a remote server, the method comprising:
determining the constituent data fields of the item information, the data fields comprising descriptors relating to one or more properties of the item;
editing a descriptor for a data field of the item information in conformance with a uniform descriptor taxonomy; and
classifying the item in dependence on the edited descriptor.

17. A method according to claim 16, wherein the uniform descriptor taxonomy comprises a standardised set of descriptors.

18. A method according to claim 16 or 17, wherein the item information is determined via remote querying of the remote server over a computer network.

19. A method according to claim 18, wherein the remote querying is by means of an agent or spider adapted to crawl a website associated with the remote server.

20. A method according to any of claims 16 to 19, further comprising storing the item information and the edited descriptor in a database.

21. A method according to any of claims 16 to 20, wherein editing a descriptor comprises replacing the descriptor with a more suitable descriptor.

22. A method according to claim 21, wherein the descriptor is selected from the standardised set of descriptors.

23. A method according to any of claims 16 to 22, wherein editing a descriptor is in dependence on at least one item property.

24. A method according to any of claims 16 to 23, further comprising obtaining additional item information from a data feed from a remote server.

25. A method according to claim 24, further comprising determining the item property from the data feed.

26. A method according to claim 24 or 25, wherein the data feed comprises a structured document detailing items available from the merchant.

27. A method according to claim 26, wherein the structured document contains a textual description of the item.

28. A method according to any of claims 21 to 27, further comprising determining a suitable descriptor by the use of a Support Vector Machine SVM model.

29. A method according to claim 28, further comprising training the model on sample data, preferably on data fields present in the data feed.

30. A method according to any of claims 24 to 29, wherein the method further comprises extracting at least one data field and/or descriptor from the data feed.

31. A method according to any of claims 24 to 30, further comprising predicting at least one field not present in the data feed from the textual description of the item in the data feed.

32. A method according to claim 31, further comprising estimating the likelihood of correctness of the prediction with reference to a probability threshold.

33. A method according to claim 32, further comprising determining the probability-threshold using a bounded minimisation algorithm, more preferably by means of the Broyden-Fletcher-Goldfarb-Shanno method.

34. A method according to any of claims 16 to 33, wherein the item property comprises one of: type, category, colour, size, gender, designer, description, classification, category, sub-category, name, and product code.

35. A method according to any of claims 16 to 34, further comprising one or more of: converting colours into standard colours; performing hashing on item images; determining the item shape; analysing aspects of the description, preferably as a cross-check of the merchant classification.

36. A method according to claim any of claims 16 to 35, wherein the merchant comprises a fashion retailer and the item comprises a fashion item.

37. A method of recommending an item to a user interacting with an aggregation system, the method comprising:
determining a user recommendation weighting in dependence on user interaction with the aggregation system;
determining a system recommendation weighting in dependence on a property of the item; and
determining an item recommendation in dependence on the combination of a user and a system recommendation weightings.

38. A method of recommending an item to a user interacting with an aggregation system, the method comprising:
determining a first user recommendation weighting in dependence on a first user's interaction with the merchant system;
determining a second user recommendation weighting in dependence on a second user's interaction with the aggregation system;
and determining in dependence on at least on characteristic shared between said users an item recommendation based on the combination of the first and second user interaction weightings.

39. A method according to claim 38 wherein the shared characteristic comprises a user interaction with the aggregation system.

40. A method according to claim 39 wherein the shared characteristic comprises interaction with a similar item.

41. A method according to any of claims 37 to 40, wherein at least one recommendation weighting is set by a user-defined parameter.

42. A method according to claim 41, wherein the user-defined parameter is set directly by the user.

43. A method according to claim 41, wherein the user-defined parameter is determined from information determined from the user.

44. A method according to any of claims 37 to 43, wherein at least one recommendation weighting is adjusted as the user interacts with the merchant system.

45. A method according to any of claims 37 to 44, wherein the recommendation weighting is determined by one or more of: an external entity, another user and/or the merchant.

46. A method according to any of claims 37 to 45, further comprising ranking the items according to predicted-preference ordering.

47. A method according to claim 46, wherein the ordering is determined by means of a pairwise ranking algorithm.

48. A method according to claim 46 or 47, wherein the predicted-preference ordering is determined in dependence on one or more of: past actions of the user; item popularity; and item freshness or newness.

49. A method according to any of claims 37 to 48, further comprising generating a user preference model, the model describing the user preferences over items as a co-efficient vector.

50. A method according to claim 49, wherein the vector describes user preferences in terms of a combination of basic and latent item features, preferably computed using a collaborative filtering technique.

51. A method according to claim 49 or 50, wherein the model is determined according to a modified Weighted Alternating Least Squares WALS algorithm.

52. A method according to claim 51, wherein the modified algorithm comprises:
i) initialisation of an item latent factor matrix:
ii) computation of a user matrix, wherein the matrix comprises latent factors corresponding to item latent factors, and content coefficients corresponding to the encoded product metadata; and
iii) re-computing the factors of the item matrix via regressing the difference of the user-item matrix and the product of the content part of the user and item matrices on user latent factors.

53. A method according to claim 52, wherein the initialisation of the latent factor matrix comprises:
i) initialising the latent item factors using small random values; and
ii) initialising the content-based part of the item matrix using a matrix encoding of item metadata.

54. A method according to any of claims 49 to 53, further comprising generating a product preference model and wherein when combined, user and product models yield personalized ranking scores, for all users over all items.

55. A method according to any of claims 49 to 54, further comprising combining or grouping products into a set that is both pleasing to the user as a whole (for example, according to parameters determined to be of importance to the user and/or aesthetically) and meets certain merchandising requirements.

56. A method of maintaining data integrity when updating a database of item data, the item data being obtained via remote querying of a merchant server for data relating to a property of the item, the method comprising:
obtaining a new property value; comparing the new property value to a reference;
identifying whether the new property value is unlikely to be valid and if so, omitting the new property value when updating the database.

57. A method according to claim 56, wherein the reference is recalculated as successive property values are determined.

58. A method according to claim 56 or 57, wherein the reference comprises a probability distribution for the value of the property of the item.

59. A method according to claim 58, wherein the reference is determined via a running variance calculation.

60. A method according to claim 58, wherein the probability distribution is a lognormal distribution.

61. A method according to any of claims 56 to 60, wherein the property value is a price.

62. A method according to any of claims 56 to 61, wherein the new property value is determined to be invalid if it deviates from the reference by in excess of a pre-determined amount.

63. A method according to claim 56 or 57, wherein the reference comprises a set of previous property values.

64. A method according to claim 63, wherein the new property value is determined to be invalid if it is determined to not be a member of the set of previous values.

65. A method according to claim 64, wherein membership of the set of previous values is determined by means of a bloom filter.

66. A method of determining duplicate database entries
wherein the database entries correspond to images
the method comprising:
retrieving an image to be added to the database,
determining a plurality of image descriptors for said image,
comparing said descriptors with existing image descriptors corresponding to existing images in the database to determine potential duplication; and
outputting an optimised database.

67. A method according to claim 66 wherein the image descriptors are dependent on physical characteristics of said image.

68. A method according to claim 66 or 67 wherein the descriptors are clustered by their multiplicity prior to comparison.

69. A method according to any of claims 66 to 68 wherein the coparing comprises determining a statistical measure of similarity.

70. A method according to claim 69 wherein textual descriptors associated with said images are utilised in determining a measure of similarity.

71. A method according to claim 69 or 70 wherein the statistical measure is Chi squared.

72. A method according to any one of claims 66 to 71 wherein the descriptors are BRISK descriptors.

73. A method according to any one of claims 66 to 72 wherein the retrieved images are images retrieved from external data sources.

74. A method of dynamically updating a database on an aggregation server, the method comprising:
accessing data on a remote server, the data relating to at least one item with at least one associated characteristic;
updating the entry in the database corresponding to said characteristic;
wherein said updating is triggered by a user interaction with said aggregation server.

75. A method according to claim 74 wherein the user interaction comprises at least one of: adding an item and/or a related item to a shopping basket, viewing a web page corresponding to said item and/or a related item, selecting/deselecting an item and/or a related item.

76. A method of routing a request in a network, the method comprising:
determining a geographical identifier associated with the request;
determining a proxy server having a geographical identifier in dependence on the geographical identifier of the request; and
routing the request to a server via the proxy server.

77. A method according to claim 76 wherein determining the geographical location of the request is in dependence on user provided information.

78. A method according to claim 77 wherein the user provided information comprises at least one of: a user address, billing address or delivery address.

79. A method of image processing, the method comprising:
determining edges of a foreground element within said image;
determining a threshold level distinguishing between foreground and background;
flood filling the image around said foreground element;
creating a mask corresponding to the flood-filled area;
attenuating the background by applying mask to original image.

80. A method according to claim 79 wherein the step of determining edges of a foreground element is performed by negating the images.

81. A method according to claim 79 or 80 wherein a Sobel filter is utilised to determine the edges of said foreground element.

82. A method according to any of claims 79 to 81 wherein the determined edges are blurred.

83. A method according to claim 70 wherein the blur is a Gaussian blur.

84. A method according to any of claims 79 to 83 wherein the threshold level is determined on a local level.

85. A method of determining a text descriptor of at least one predominant colour in an image, the image comprising a plurality of coloured areas the method comprising:
determining the predominant colour values for the plurality of coloured areas,
translating said predominant colour value into a text descriptor.

86. A method according to claim 85 wherein translating the predominant colour value into a colour name comprises determining the colour difference to at least one known colour value, the closest known colour value being elected as the colour name.

87. A method according to claim 86 wherein the predominant colour values and colour text descriptors are mapped onto a colour space.

88. A method according to any of claims 85 to 87 wherein the colour space is CIE lab color space, preferably CIE2000.

89. A method according to claim 87 or 88 wherein the closest known colour value is determined by a colour difference function determining the magnitude of the separation between the mapped predominant colour value and colour names, preferably a deltaE function.

90. A method according to any of claims 85 to 89 comprising attenuating the background of said image, preferably according to claims 79 to 84.

91. A method according to any of claims 85 to 90 wherein the size and/or number of coloured areas of the image are dynamically determined in dependence on image characteristics.

92. A method according to claim 91 wherein the image characteristics comprise: the homogeneity of colours in the image, the indication of the image, the resolution of the image.

93. A method according to any of claims 85 to 92 wherein thresholds are applied to certain colour values.

94. A method according to any of claims 85 to 93 further comprising moderating the colour text descriptors, preferably by a human operator or system user.

95. A method of selecting an image most indicative of an item from a set of images, the method comprising:
(a) determining a foreground element from a plurality of images known to be indicative of an item;
(b) inputting said elements into a statistical model;
determining a foreground element from each of said set of images;
determining which foreground element fits the statistical model best,
selecting the image corresponding to this foreground element as being most indicative of said item.

96. A method of determining an item type depicted by an image, the method comprising:
(a) determining a foreground element from a plurality of images known to be indicative of an item,
(b) inputting said elements into a statistical model,
iterating steps (a) and (b) for at least two items; and
determining a foreground element of said image,
determining which statistical model said foreground element best fits,
selecting the item corresponding to this statistical model as being shown by said image.

97. A method according to claim 96 wherein the image forms part of a set of images and the method comprises selecting the image from the set of images corresponding to this foreground element as being most indicative of said item.

98. A method according to claim 96 or 97 wherein each item corresponds to a particular category or sub-category of item.

99. A method according to any of claims 96 to 98 wherein each item has a separate statistical model.

100. A method according to any of claims 95 to 99 wherein the item is an item of clothing, jewelry, footwear, luggage or accessory.

101. A method according to any of claims 95 to 100 wherein the set of images correspond to a plurality of different views of said item.

102. A method according to any of claims 95 to 101 wherein the statistical model is a random forest model.

103. A method according to any of claims 95 to 102 wherein the plurality of images known to be indicative of an item are selected based on rules for a particular item governing the most indicative view of said item.

104. A method according to claim 103 wherein said rules comprise at least one of: most common view, most informative view, most flattering view.

105. A method of user authentication, comprising the steps of:
receiving, from a user, user data at a first entity;
determining in dependence on the user data the existence of a related user account at a second entity; and
in the absence of a related user account either:
a) generating a new user account, in dependence on the user data, at the second entity; or
b) requesting, from the user, further user data, relating to a valid user account at the second entity.

106. A method according to claim 105 wherein the existence of the related user account is determined at the first entity.

107. A method according to claim 105 comprising forwarding the user data from the first entity to the second entity and determining the existence of the related user account at the second entity.

108. A method according to any of claims 105 to 107, comprising determining in dependence on the user data the existence of related user accounts at a plurality of further entities; and in the absence of related user accounts either:
a) generating new user accounts, in dependence on the user data, at the further entities; and/or
b) requesting, from the user, further user data, relating to valid user accounts at the further entity.

109. A method according to any of claims 105 to 108, wherein the user data comprises at least one of: usernames: emails; passwords; payment data; user billing and shipping addresses.

110. A method according to any of claims 105 to 109, further comprising generating a password for at least one new user account.

111. A method according to any of claims 105 to 110, further comprising submitting a transaction order from the first entity to the second or at least one further entity.

112. A method of facilitating a user transaction, comprising the steps of:
receiving, from the user, at a first entity, constituent elements of a transaction to be conducted at a second entity;
determining, in dependence on the elements of the transaction, the necessity for a user account at the second entity in order to facilitate the transaction; and
generating, at a first entity, a notification in the event a user account is determined to be necessary.

113. A method substantially as herein described with reference to the accompanying drawings.

114. Apparatus substantially as herein described with reference to the accompanying drawings.
